(19) United States
(12) Patent Application Publication
(10) Pub. No.: US 2025/0390783 A1
(43) Pub. Date: Dec. 25, 2025

(54) APPARATUS AND A METHOD FOR ASSIGNING ONE OR MORE PROPOSAL CODES TO A REQUEST FOR PROPOSAL

(71) Applicant: Abundat LLC, Mansfield, OH (US)

(72) Inventor: Evan Ryan, Lucas, OH (US)

(73) Assignee: Abundat LLC, Mansfield, OH (US)

(21) Appl. No.: 18/748,492

(22) Filed: Jun. 20, 2024

(51) Int. Cl. G06N 20/00

(52) U.S. Cl. CPC G06N 20/00

(57) ABSTRACT

An apparatus for assigning one or more proposal codes to a request for proposal is disclosed. The apparatus includes a processor and a memory communicatively connected to the processor. The memory instructs the processor to receive a plurality of profiles and at least one RFP. The memory instructs the processor to identify a set of implicit data objects for the at least one RFP. The memory instructs the processor to assign one or more proposal codes to each implicit data object of the set of implicit data objects. The memory instructs the processor to generate a vendor score for each profile as a function of a comparison of each profile to the one or more proposal codes. The memory instructs the processor to match at least one profile of the plurality of profiles to the at least one RFP as a function of the vendor score.

### FIELD OF THE INVENTION

The present invention generally relates to the field of data management. In particular, the present invention is directed to an apparatus and a method for assigning one or more proposal codes to a request for proposal.

### BACKGROUND

Many computer processes require structured data to operate effectively, yet much of the data available today is unstructured. This includes text, images, videos, and other forms of data that do not fit neatly into predefined data models. It has long been a long been an issue to develop methods to convert this unstructured data into a structured format that can be easily analyzed and processed by algorithms.

### SUMMARY OF THE DISCLOSURE

In an aspect, an apparatus for assigning one or more proposal codes to a request for proposal is disclosed. The memory instructs the processor to receive a plurality of profiles. The memory instructs the processor to receive at least one request for proposal (RFP). The memory instructs the processor to identify a set of implicit data objects for the at least one RFP. The memory instructs the processor to assign one or more proposal codes to each implicit data object of the set of implicit data objects. Assigning the one or more proposal codes includes training a code machine learning model using code training data, wherein the code training data comprises examples of implicit data objects as inputs correlated to examples of proposal codes as outputs and assigning the one or more proposal codes to each implicit data object of the set of implicit data objects using the trained identifier machine learning model. The memory instructs the processor to generate a vendor score for each profile as a function of a comparison of each profile to the one or more proposal codes. The memory instructs the processor to match at least one profile of the plurality of profiles to the at least one RFP as a function of the vendor score.

In another aspect, a method for assigning one or more proposal codes to a request for proposal is disclosed. The method includes receiving, using at least a processor, a plurality of profiles. The method includes receiving, using the at least a processor, at least one request for proposal (RFP). The method includes identifying, using the at least a processor, a set of implicit data objects for the at least one RFP. The method includes assigning, using the at least a processor, one or more proposal codes to each implicit data object of the set of implicit data objects. Assigning the one or more proposal codes includes training a code machine learning model using code training data, wherein the code training data comprises examples of implicit data objects as inputs correlated to examples of proposal codes as outputs and assigning the one or more proposal codes to each implicit data object of the set of implicit data objects using the trained identifier machine learning model. The method includes generating, using the at least a processor, a vendor score for each profile as a function of a comparison of each profile to the one or more proposal codes. The method includes matching, using the at least a processor, at least one profile of the plurality of profiles to the at least one RFP as a function of the vendor score.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a block diagram of an exemplary embodiment of an apparatus for assigning one or more proposal codes to a request for proposal;

FIG. 2 is a block diagram of an exemplary machine-learning process;

FIG. 3 is a block diagram of an exemplary embodiment of a proposal database;

FIG. 4 is a diagram of an exemplary embodiment of a neural network;

FIG. 5 is a diagram of an exemplary embodiment of a node of a neural network;

FIG. 6 is an illustration of an exemplary embodiment of fuzzy set comparison;

FIG. 7 is an illustration of an exemplary embodiment of a chatbot;

FIG. 8 is an illustration of an exemplary user interface;

FIG. 9 is a flow diagram of an exemplary method for assigning one or more proposal codes to a request for proposal; and

FIG. 10 is a block diagram of a computing system that can be used to implement any one or more of the methodologies disclosed herein and any one or more portions thereof.

The drawings are not necessarily to scale and may be illustrated by phantom lines, diagrammatic representations, and fragmentary views. In certain instances, details that are not necessary for an understanding of the embodiments or that render other details difficult to perceive may have been omitted.

### DETAILED DESCRIPTION

At a high level, aspects of the present disclosure are directed to an apparatus and a method for assigning one or more proposal codes to a request for proposal. The memory instructs the processor to receive a plurality of profiles. The memory instructs the processor to receive at least one request for proposal (RFP). The memory instructs the processor to identify a set of implicit data objects for the at least one RFP. The memory instructs the processor to assign one or more proposal codes to each implicit data object of the set of implicit data objects. Assigning the one or more proposal codes includes training a code machine learning model using code training data, wherein the code training data comprises examples of implicit data objects as inputs correlated to examples of proposal codes as outputs and assigning the one or more proposal codes to each implicit data object of the set of implicit data objects using the trained identifier machine learning model. The memory instructs the processor to generate a vendor score for each profile as a function of a comparison of each profile to the one or more proposal codes. The memory instructs the processor to match at least one profile of the plurality of profiles to the at least one RFP as a function of the vendor score.

In some cases, embodiments described herein may address the challenge of structuring unstructured data. Apparatus 100 may transform raw and unstructured inputs into organized, analyzable formats that may facilitate the subsequent automation of data evaluation processes. Without this initial structuring, the automation and systematic assessment of such data may prove to be increasingly difficult. By facilitating this transformation, apparatus 100 may enable sophisticated algorithmic tools to engage effectively with the data, applying advanced analytics and decision-making processes that rely on the structured nature of the data to deliver accurate and consistent evaluations. This innovation is pivotal for enhancing efficiency and accuracy in fields that depend heavily on data-driven insights.

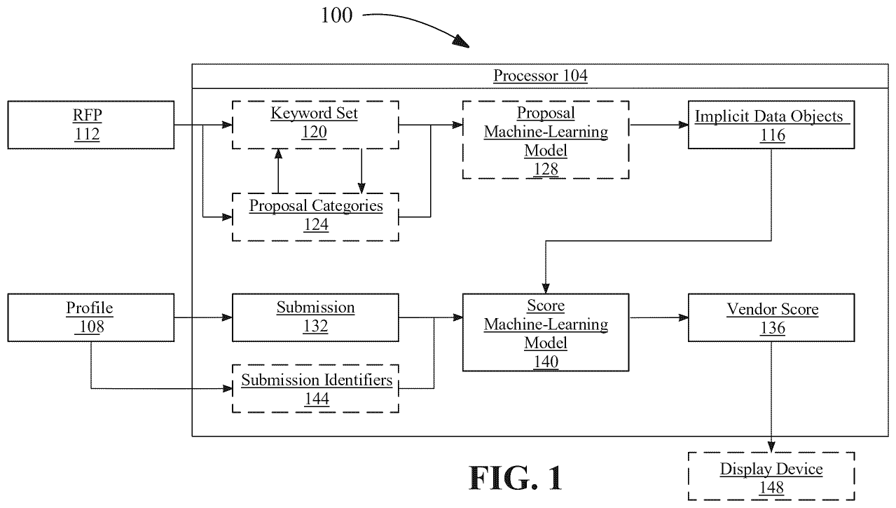

Referring now to FIG. 1, an exemplary embodiment of an apparatus 100 for assigning one or more proposal codes to a request for proposal is illustrated. Apparatus 100 includes a processor 104. Processor 104 may include any computing device as described in this disclosure, including without limitation a microcontroller, microprocessor, digital signal processor (DSP) and/or system on a chip (SoC) as described in this disclosure. Computing device may include, be included in, and/or communicate with a mobile device such as a mobile telephone or smartphone. Processor 104 may include a single computing device operating independently, or may include two or more computing device operating in concert, in parallel, sequentially or the like; two or more computing devices may be included together in a single computing device or in two or more computing devices. Processor 104 may interface or communicate with one or more additional devices as described below in further detail via a network interface device. Network interface device may be utilized for connecting processor 104 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Processor 104 may include but is not limited to, for example, a computing device or cluster of computing devices in a first location and a second computing device or cluster of computing devices in a second location. Processor 104 may include one or more computing devices dedicated to data storage, security, distribution of traffic for load balancing, and the like. Processor 104 may distribute one or more computing tasks as described below across a plurality of computing devices of computing device, which may operate in parallel, in series, redundantly, or in any other manner used for distribution of tasks or memory between computing devices. Processor 104 may be implemented using a “shared nothing” architecture in which data is cached at the worker, in an embodiment, this may enable scalability of apparatus 100 and/or computing device.

With continued reference to FIG. 1, processor 104 may be designed and/or configured to perform any method, method step, or sequence of method steps in any embodiment described in this disclosure, in any order and with any degree of repetition. For instance, processor 104 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Processor 104 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

With continued reference to FIG. 1, apparatus 100 includes a memory. Memory is communicatively connected to processor 104. Memory may contain instructions configuring processor 104 to perform tasks disclosed in this disclosure. As used in this disclosure, “communicatively connected” means connected by way of a connection, attachment, or linkage between two or more relata which allows for reception and/or transmittance of information therebetween. For example, and without limitation, this connection may be wired or wireless, direct, or indirect, and between two or more components, circuits, devices, systems, apparatus, and the like, which allows for reception and/or transmittance of data and/or signal(s) therebetween. Data and/or signals therebetween may include, without limitation, electrical, electromagnetic, magnetic, video, audio, radio, and microwave data and/or signals, combinations thereof, and the like, among others. A communicative connection may be achieved, for example, and without limitation, through wired or wireless electronic, digital, or analog, communication, either directly or by way of one or more intervening devices or components. Further, communicative connection may include electrically coupling or connecting at least an output of one device, component, or circuit to at least an input of another device, component, or circuit. For example, without limitation, via a bus or other facility for intercommunication between elements of a computing device. Communicative connecting may also include indirect connections via, for example, and without limitation, wireless connection, radio communication, low power wide area network, optical communication, magnetic, capacitive, or optical coupling, and the like. In some instances, the terminology “communicatively coupled” may be used in place of communicatively connected in this disclosure.

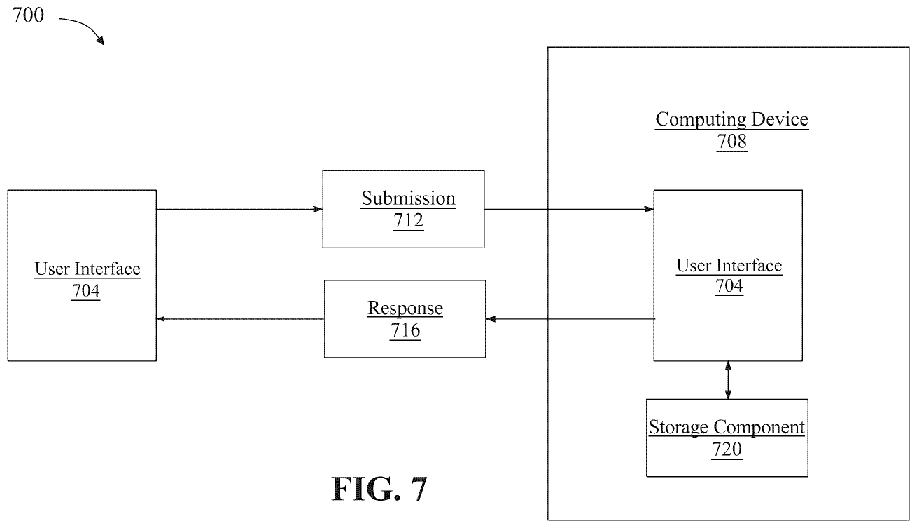

With continued reference to FIG. 1, processor 104 is configured to receive a plurality of profiles 108. For the purposes of this disclosure, a “profile” is a representation of information and/or data associated with an entity. A profile 108 may include a plurality of vendor data. As used in the current disclosure, “vendor data” is information associated with the vendor. A profile 108 may be created by a processor 104, a user, or a third party. As used in the current disclosure, a “vendor” is a person or a group of people with a common objective. A vendor may include a corporation, a business, an organization, a retail store, an individual, and the like. The profile 108 may include information regarding the entity's industry, sales history, revenue, customers, products, customer demographics, employee demographics, equipment, inventory, and the like. Vendor data may be provided by a user directly, database, third-party application, API, remote device, immutable sequential listing, social media profile, and the like. Vendor data may be generated using the responses to a chatbot. Chatbots are discussed in greater detail with respect to FIG. 7. A profile 108 may include a plurality of structured or unstructured data.

Referring again to FIG. 1, profile 108 may encompass vendor statistics. In this disclosure, “vendor statistic” refers to data concerning the characteristics and activities of an organization or business entity. Vendor statistics may cover various attributes such as industry type, business size, location, financial status, business credit, organizational demographics, historical business activities, and areas of operation. Furthermore, vendor statistics can include detailed records associated with business operations such as business addresses, tax identification numbers, contact information, employment structures, social media presence, geographic distribution of operations, revenue streams, customer engagement metrics, business purchase history, and an entity's digital presence.

With continued reference to FIG. 1, a profile 108 may be received by processor 104 through user input. In some embodiments, profile 108 and/or submission 140 may be retrieved using an API. For example, and without limitation, the user or a third party may manually input profile 108 using a graphical user interface of processor 104 or a remote device, such as for example, a smartphone or laptop. Profile 108 may additionally be generated via the answer to a series of questions. The series of questions may be implemented using a chatbot, as described herein below. A chatbot may be configured to generate questions regarding any element of profile 108, vendor data, and the like. In a non-limiting embodiment, a user may be prompted to input specific information or may fill out a questionnaire. In an embodiment, a graphical user interface may display a series of questions to prompt a user for information pertaining to profile 108. Profile 108 may be transmitted to processor 104, such as using wired or wireless communication, as previously discussed in this disclosure. Profile 108 can be retrieved from multiple third-party sources including the user's inventory records, financial records, human resource records, past entity profiles 108, sales records, user notes and observations, and the like. Profile 108 may be placed through an encryption process for security purposes.

With continued reference to FIG. 1, Profile 108 may include vendor records. As used in the current disclosure, a “vendor record” is a document that contains information regarding the entity. Vendor records may include client demographics, sales records, and inventory records. Vendor record may include things like client files, invoices, time cards, driver's license databases, news articles, social media profiles and/or posts, and the like. Entity records may be identified using a web crawler. Vendor records may be converted into machine-encoded text using an optical character reader (OCR).

Still referring to FIG. 1, in some embodiments, optical character recognition or optical character reader (OCR) includes automatic conversion of images of written (e.g., typed, handwritten, or printed text) into machine-encoded text. In some cases, recognition of at least a keyword from an image component may include one or more processes, including without limitation optical character recognition (OCR), optical word recognition, intelligent character recognition, intelligent word recognition, and the like. In some cases, OCR may recognize written text, one glyph or character at a time. In some cases, optical word recognition may recognize written text, one word at a time, for example, for languages that use a space as a word divider. In some cases, intelligent character recognition (ICR) may recognize written text one glyph or character at a time, for instance by employing machine learning processes. In some cases, intelligent word recognition (IWR) may recognize written text, one word at a time, for instance by employing machine learning processes.

Still referring to FIG. 1, in some cases, OCR may be an “offline” process, which analyses a static document or image frame. In some cases, handwriting movement analysis can be used as input for handwriting recognition. For example, instead of merely using shapes of glyphs and words, this technique may capture motions, such as the order in which segments are drawn, the direction, and the pattern of putting the pen down and lifting it. This additional information can make handwriting recognition more accurate. In some cases, this technology may be referred to as “online” character recognition, dynamic character recognition, real-time character recognition, and intelligent character recognition.

Still referring to FIG. 1, in some cases, OCR processes may employ pre-processing of image components. Pre-processing process may include without limitation de-skew, de-speckle, binarization, line removal, layout analysis or “zoning,” line and word detection, script recognition, character isolation or “segmentation,” and normalization. In some cases, a de-skew process may include applying a transform (e.g., homography or affine transform) to the image component to align text. In some cases, a de-speckle process may include removing positive and negative spots and/or smoothing edges. In some cases, a binarization process may include converting an image from color or greyscale to black-and-white (i.e., a binary image). Binarization may be performed as a simple way of separating text (or any other desired image component) from the background of the image component. In some cases, binarization may be required for example if an employed OCR algorithm only works on binary images. In some cases, a line removal process may include the removal of non-glyph or non-character imagery (e.g., boxes and lines). In some cases, a layout analysis or “zoning” process may identify columns, paragraphs, captions, and the like as distinct blocks. In some cases, a line and word detection process may establish a baseline for word and character shapes and separate words, if necessary. In some cases, a script recognition process may, for example in multilingual documents, identify a script allowing an appropriate OCR algorithm to be selected. In some cases, a character isolation or “segmentation” process may separate signal characters, for example, character-based OCR algorithms. In some cases, a normalization process may normalize the aspect ratio and/or scale of the image component.

Still referring to FIG. 1, in some embodiments, an OCR process will include an OCR algorithm. Exemplary OCR algorithms include matrix-matching process and/or feature extraction processes. Matrix matching may involve comparing an image to a stored glyph on a pixel-by-pixel basis. In some cases, matrix matching may also be known as “pattern matching,” “pattern recognition,” and/or “image correlation.” Matrix matching may rely on an input glyph being correctly isolated from the rest of the image component. Matrix matching may also rely on a stored glyph being in a similar font and at the same scale as input glyph. Matrix matching may work best with typewritten text.

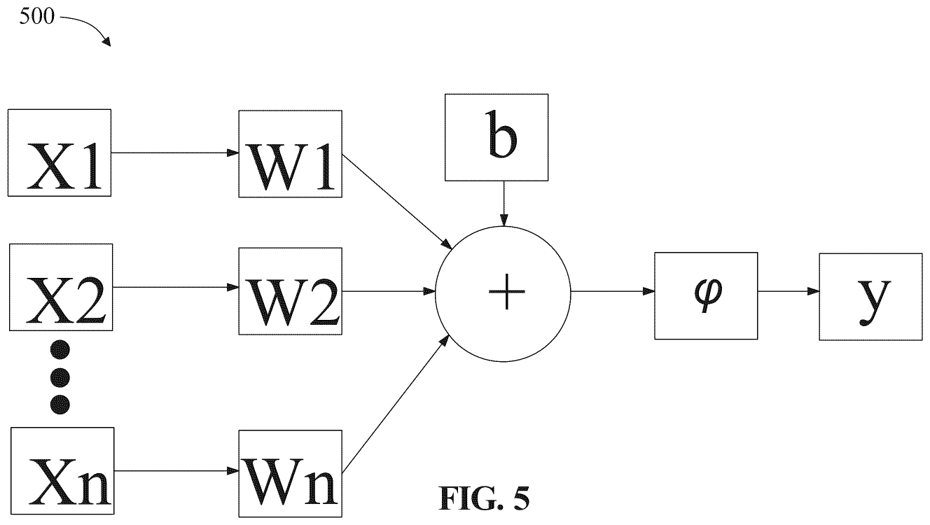

Still referring to FIG. 1, in some embodiments, an OCR process may include a feature extraction process. In some cases, feature extraction may decompose a glyph into features. Exemplary non-limiting features may include corners, edges, lines, closed loops, line direction, line intersections, and the like. In some cases, feature extraction may reduce dimensionality of representation and may make the recognition process computationally more efficient. In some cases, extracted feature can be compared with an abstract vector-like representation of a character, which might reduce to one or more glyph prototypes. General techniques of feature detection in computer vision are applicable to this type of OCR. In some embodiments, machine-learning process like nearest neighbor classifiers (e.g., k-nearest neighbors algorithm) can be used to compare image features with stored glyph features and choose a nearest match. OCR may employ any machine-learning process described in this disclosure, for example machine-learning processes described with reference to FIGS. 5-7. Exemplary non-limiting OCR software includes Cuneiform and Tesseract. Cuneiform is a multi-language, open-source optical character recognition system originally developed by Cognitive Technologies of Moscow, Russia. Tesseract is free OCR software originally developed by Hewlett-Packard of Palo Alto, California, United States.

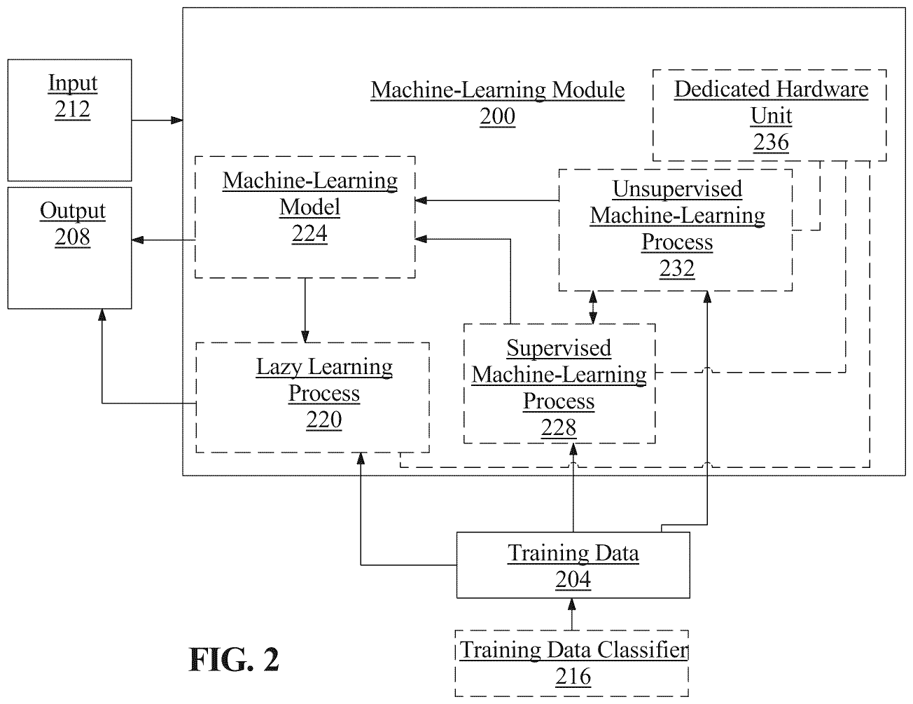

Still referring to FIG. 1, in some cases, OCR may employ a two-pass approach to character recognition. The second pass may include adaptive recognition and use letter shapes recognized with high confidence on a first pass to recognize better remaining letters on the second pass. In some cases, two-pass approach may be advantageous for unusual fonts or low-quality image components where visual verbal content may be distorted. Another exemplary OCR software tool include OCRopus. OCRopus development is led by German Research Centre for Artificial Intelligence in Kaiserslautern, Germany. In some cases, OCR software may employ neural networks, for example neural networks as taught in reference to FIGS. 2, 4, and 5.

Still referring to FIG. 1, in some cases, OCR may include post-processing. For example, OCR accuracy can be increased, in some cases, if output is constrained by a lexicon. A lexicon may include a list or set of words that are allowed to occur in a document. In some cases, a lexicon may include, for instance, all the words in the English language, or a more technical lexicon for a specific field. In some cases, an output stream may be a plain text stream or file of characters. In some cases, an OCR process may preserve an original layout of visual verbal content. In some cases, near-neighbor analysis can make use of co-occurrence frequencies to correct errors, by noting that certain words are often seen together. For example, “Washington, D.C.” is generally far more common in English than “Washington DOC.” In some cases, an OCR process may make use of a priori knowledge of grammar for a language being recognized. For example, grammar rules may be used to help determine if a word is likely to be a verb or a noun. Distance conceptualization may be employed for recognition and classification. For example, a Levenshtein distance algorithm may be used in OCR post-processing to further optimize results.

With continued reference to FIG. 1, profile 108 may be generated using a web crawler. A “web crawler,” as used herein, is a program that systematically browses the internet for the purpose of Web indexing. The web crawler may be seeded with platform URLs, wherein the crawler may then visit the next related URL, retrieve the content, index the content, and/or measures the relevance of the content to the topic of interest. In some embodiments, processor 104 may generate a web crawler to compile profile 108. The web crawler may be seeded and/or trained with a reputable website, such as the user's business website, to begin the search. A web crawler may be generated by processor 104. In some embodiments, the web crawler may be trained with information received from a user through a user interface. In some embodiments, the web crawler may be configured to generate a web query. A web query may include search criteria received from a user. For example, a user may submit a plurality of websites for the web crawler to search to extract user records, inventory records, financial records, human resource records, past profile 108, social media profiles, sales records, user notes, and observations, based on criteria such as a time, location, and the like.

With continued reference to FIG. 1, processor 104 is configured to receive at least one request for proposal (RFP) 112. For the purposes of this disclosure, a “request for proposal” is a document that an entity issues to solicit proposals from potential suppliers or service providers. This process is part of procurement and is used when an organization wants to acquire a significant product or service, or when the solution to a particular need is not straightforward and requires a detailed explanation from various vendors. An RFP 112 may be used to outline the organization's needs in a detailed and structured manner, allowing vendors to offer competitive solutions that meet these requirements. An RFP 112 may also be used when the value and complexity of the service or product require careful consideration and comparison of multiple vendors' capabilities and offerings. RFPs may be received in both structured and unstructured formats.

With continued reference to FIG. 1, in some embodiments, processor 104 may be configured to retrieve RFP 112 using a web crawler. A web crawler, as described herein above, may be a software application designed to systematically browse the internet and gather information from websites according to specific criteria. The processor 104 may determine potential sources where the required data might be found. This includes public databases, industry publications, official regulatory bodies' websites, trade associations, state RFP websites, industry RFP websites, federal RFP websites, and the like. Once the web crawler has been seeded, processor 104 may set up the web crawler with specific keywords, URLs, and search parameters related to the identified data gaps. The crawler may also be programmed with algorithms to navigate through web pages, follow links, and respect the robots.txt files to ensure ethical scraping practices. As the web crawler traverses the web, it may use techniques like HTML parsing, API calls, or even machine learning models to identify, extract, and collect data that matches the predefined criteria. This data is then extracted from web pages and stored in a structured format for further processing. In an embodiment, the extracted data may require cleaning and validation to ensure it is accurate, relevant, and usable. Processor 104 may apply data cleaning techniques to remove duplicates, correct errors, and format the data consistently. Validation checks may also be performed to ensure the data has not expired. In some embodiments, processor 104 may be configured to retrieve RFP 112 using an API. For example, API may interface with federal RFP websites, state RFP websites, local RFP websites, industry RFP websites, and the like. In some embodiments, processor 104 may be configured to receive RFP 112 from a user submission.

With continued reference to FIG. 1, the contents of an RFP 112 may include information that allows all participating vendors have a clear and comprehensive understanding of what the issuing organization requires. The RFP 112 may include an overview of the issuing organization, including its background, mission, and the specific objectives it aims to achieve with the project in question. This section may set the stage by elucidating the purpose behind the RFP 112 and the project's strategic significance to the organization. An RFP 112 may also include a scope of work for the project. This section may include a detailed account of the project requirements. This part may outline the technical specifications, expected deliverables, performance criteria, performance indicators, and the tasks that the selected vendor will be responsible for. It is crucial for laying out the exact nature of the work, ensuring that proposals are tailored to meet these specific needs. In an embodiment, submission guidelines may be included with in the RFP 112. Submission guidelines may provide explicit instructions on how proposals should be prepared and submitted. This section may detail the format of the proposal, any supporting documents that need to be included, the submission deadline, and contact details for submission. It may also specify the language and other procedural requirements to standardize the evaluation process. The RFP 112 may also include information related to the timeline, budget, terms and conditions, and the like of the proposal. The timeline component of the RFP 112 may delineate delineates the schedule for the entire RFP process, from the proposal submission deadline through various phases like evaluation, negotiations, and final decision-making, to the anticipated start date of the project. Budget considerations may also be addressed in an RFP 112. A budget may indicate the financial constraints within which the proposals must fit. This part often includes the maximum budget allowed for the project, encouraging vendors to submit cost-effective solutions and financial plans that demonstrate value for money.

With continued reference to FIG. 1, processor 104 is configured to identify a set of implicit data objects 116 for the at least one RFP 112. As used in current disclosure, a “implicit data object” is any piece of data that intrinsically contains information pertinent to an RFP but is not explicitly labeled or defined as a requirement within the raw, unstructured data. These implicit data objects 116 may contain specific criteria or required information, which, although not initially marked or identified as such, hold significant relevance to the proposal. By recognizing these implicit data objects, the system may be enabled to automatically process and evaluate RFPs more effectively, extracting essential information that would otherwise require manual identification and analysis. This capability not only streamlines the evaluation process but also ensures that key requirements are not overlooked, enhancing the accuracy and efficiency of the response to the RFP. In an embodiment, implicit data objects 116 may encompass a broad range of elements embedded within unstructured data. This may include historical data points such as past decisions or project outcomes, though not marked, could provide invaluable context for current evaluations. Implicit data objects 116 may include geographical markers. This may include locations and place names mentioned in text are essential for regional analysis or compliance, yet are often not flagged as geographic data. In some cases, technical specifications or budgetary figures scattered throughout a document may be considered an implicit data object 116.

With continued reference to FIG. 1, implicit data objects 116 may represent proposal requirements such as qualifications, project timelines, or budget estimates that are embedded in the text of a proposal but not explicitly defined as requirements. As used in the current disclosure, a “proposal requirement” is the necessary criteria and standards that a profile must meet to be considered for selection. Proposal requirements may provide detailed guidelines on what the issuing organization expects in the submitted proposals, ensuring that all submissions are evaluated on a consistent and fair basis. Proposal requirements can vary widely depending on the project's scope and the organization's specific needs but typically include several key elements. The implicit data objects 116 or proposal requirements may specify the technical and functional capabilities that the vendor needs to demonstrate, such as specific skills, technologies, methodologies, or experiences relevant to the project. This may ensure that vendor represented by the profile 108 possesses the necessary expertise to successfully deliver on the project's objectives. Additionally, financial stability and the ability to allocate sufficient resources for the duration of the project are often critical criteria, assuring the organization that the vendor can sustain the project financially and operationally without risk of disruption. In an embodiment, proposal requirements might include the need for compliance with industry standards or regulatory requirements, which is particularly important in sectors like healthcare, finance, and government contracting. Vendors must demonstrate not only their adherence to these standards but also their methods for maintaining compliance throughout the project lifecycle. The proposal requirements may include evidence of past performance and references that showcase the vendor's ability to deliver similar projects successfully. This aspect of the criteria serves to validate the vendor's reputation and reliability, reducing the risk for the organization issuing the RFP. Additionally, the proposal requirements may y detail the format and structure of the proposal submission, including specific documents to be included, such as technical specifications, detailed budget breakdowns, project timelines, and staffing plans. This structure helps in comparing proposals side-by-side on equal footing, making it easier for evaluators to assess each vendor's offer systematically.

With continued reference to FIG. 1, analyzing an RFP 112 to identify implicit data objects 116 may include several computational steps that utilize natural language processing (NLP) and text analysis techniques. Processor 104 may need to scan and digitize the RFP document if it's not already in a digital format. This may be done using OCR as discussed in greater detail herein above. As used in this disclosure, a “natural language processing (NLP) model” is a computational model designed to process and comprehend human language. It utilizes techniques from machine learning, linguistics, and computer science, enabling the computer to interpret and generate natural language text effectively. The NLP model preprocesses the textual data from the RFP 112, which may involve tasks such as tokenization (splitting text into individual words or sub-word units), normalizing the text (e.g., lowercasing, removing punctuation), and encoding the text into a numerical format suitable for analysis. The model may include a transformer architecture, employing deep learning models that utilize attention mechanisms to capture relationships between words or sub-word units in a text sequence, emphasizing the importance of certain terms relevant to implicit data objects.

With continued reference to FIG. 1, The processor 104 may utilize named entity recognition (NER) to identify and classify significant terms from the RFP 112 that indicate implicit data objects 116. This involves detecting and extracting terms that are critical for understanding what is being asked in the RFP, such as specific qualifications, project milestones, or submission deadlines. The relationships between these significant terms, including statistical correlations, are analyzed to understand their relevance and implications concerning the RFP's criteria for selecting a vendor. The analysis might include determining the likelihood that certain terms point to specific categories of implicit data objects, such as technical specifications or financial conditions.

With continued reference to FIG. 1, processor 104 may also identify keyword sets 120 within the RFP 112, which are crucial for understanding the scope of implicit data objects 116. As used in the current disclosure, a “keyword set” is a collection of relevant words or phrases selected to represent aspects of the RFP 112. Keyword sets 120 may be derived from analyzing the textual content of the RFP 112, or any other related data that outlines what the task entails and what is needed to complete it. Processor 104 may identify keyword sets 120 as a function of tokenizing the text of the RFP 112, where tokenization involves breaking down the text into smaller units or ‘tokens’ such as words, phrases, or significant terms related to the RFP's content. The keyword sets 120 might include terms like “budget constraints,” “compliance requirements,” “delivery timelines,” and other phrases that relate to the critical elements of the implicit data objects. In identifying these keyword sets 120 and named entities, the processor 104 may use various NLP techniques, including tokenization to dissect sentences or phrases into components that reveal underlying requirements. This granular analysis may allow for a deeper understanding of the text, aiding in the accurate extraction of relevant keywords and phrases that form part of the implicit data objects 116.

With continued reference to FIG. 1, an NLP may tokenize text within the RFP 112 to identify keyword sets 120 and/or named entities. This may be done by breaking down the text into smaller units or ‘tokens’. In this process, a sentence or a phrase is segmented into words, phrases, symbols, or other meaningful elements that serve as the basic building blocks for analysis. For example, in the sentence “The vendor is not to exceed a total budget of 1 million dollars for the upcoming project.” Tokenization may divide this into individual keyword sets 120 like “Budget,” “1 million dollars,” and the like. This may allow processor 104 to analyze and understand the text at a more granular level, identifying and processing each token separately. In an embodiment, processor 104 may employ one or more artificial intelligence algorithms to identify and analyze the tokenized text. In an embodiment, at least a portion of the tokens that are identified by the NLP may be considered keyword sets 120. Identifying keyword sets from tokenized textual data may involve processing and analyzing the text to extract meaningful and relevant keywords. Once the text is tokenized, various techniques may be applied to identify keyword sets 120. These techniques may include frequency analysis, where frequently occurring tokens are considered potential keywords, or more sophisticated methods like natural language processing (NLP) techniques that analyze the context, semantic meaning, and relationships between tokens.

With continued reference to FIG. 1, processor 104 may classify the one or more keyword sets 120 or their corresponding tokens into one or more proposal categories 124. As used in the current disclosure, a “proposal category” is a classification used to organize and group specific aspects of a proposal. This may include aspects such as technical specifications, financial details, or vendor qualifications, to streamline the evaluation process. Proposal categories 124 may be used for grouping various elements of implicit data objects 116 into manageable and distinct sections, facilitating easier analysis and evaluation. These categories may correspond to different aspects of implicit data objects, such as financial proposals, technical specifications, legal compliances, project timelines, vendor qualifications, diversity equity and inclusion considerations, and the like. This classification may be based on parsing the text to detect patterns and contextual clues within the RFP 112, which helps in a structured extraction of information and in organizing and categorizing the RFP's demands efficiently. In an embodiment, a keyword set 120 might include details related to pricing models, cost breakdowns, and payment terms and the like. Each of these may be represented by a proposal categories 124. In an additional embodiment, keyword sets 120 that are related to descriptions of required technologies, engineering processes, or product functionalities that the vendor needs to provide may be classified to proposal categories 124 related to the technical specialties of the vendor. In another embodiment, an RFP 112 may cover necessary certifications, adherence to specific laws and regulations, or contractual obligations may be classified to proposal categories related to the legal compliances of the vendor. These proposal categories 124 may help ensure that each part of the RFP is addressed comprehensively, allowing evaluators to assess each proposal systematically and fairly based on predefined criteria aligned with organizational objectives.

With continued reference to FIG. 1, processor 104 may identify implicit data objects 116 using a proposal machine-learning model 128. As used in the current disclosure, a “proposal machine-learning model” is a machine-learning model that is configured to generate implicit data objects 116. Proposal machine-learning model 128 may be consistent with the machine-learning model described below in FIG. 2. Inputs to the proposal machine-learning model 128 may include RFP 112, keyword sets 120, proposal categories 124, examples of implicit data objects 116, and the like. Outputs to the proposal machine-learning model 128 may include implicit data objects 116 tailored to the RFP 112. In an embodiment, a proposal machine learning model 128 may be configured to generate implicit data objects 116 by identifying and classifying keyword sets 120 into one or more proposal categories 124. Proposal training data may include a plurality of data entries containing a plurality of inputs that are correlated to a plurality of outputs for training a processor by a machine-learning process. In an embodiment, proposal training data may include a plurality of RFP 112 correlated to examples of implicit data objects 116. Proposal training data may be received from database 300. Proposal training data may contain information about RFP 112, keyword sets 120, proposal categories 124, examples of implicit data objects 116, and the like. In an embodiment, proposal training data may be iteratively updated as a function of the input and output results of past proposal machine-learning model 128 or any other machine-learning model mentioned throughout this disclosure. The machine-learning model may be performed using, without limitation, linear machine-learning models such as without limitation logistic regression and/or naive Bayes machine-learning models, nearest neighbor machine-learning models such as k-nearest neighbors machine-learning models, support vector machines, least squares support vector machines, fisher's linear discriminant, quadratic machine-learning models, decision trees, boosted trees, random forest machine-learning model, and the like.

With continued reference to FIG. 1, a natural language processing model may include one or more algorithms and/or statistical methods that may be often built upon machine learning models such as proposal machine-learning model 128. An NLP model may be trained using large datasets of text, where they learn to recognize patterns, structures, and nuances of language. For example, models like BERT (Bidirectional Encoder Representations from Transformers) or GPT (Generative Pre-trained Transformer) may be trained on vast corpora of text from the internet, books, and other sources. During training, the internal parameters of the model may be adjusted to minimize the difference between its predictions and actual outcomes, a process known as supervised learning. In contrast, unsupervised learning approaches involve discovering patterns within the data without predefined labels.

With continued reference to FIG. 1, machine learning may enhance the function of software for identifying implicit data objects 116. This may include identifying patterns within the RFP 112 that lead to changes in the capabilities of the proposal machine-learning model 128. By analyzing vast amounts of data related to the RFP 112, machine learning algorithms can identify patterns, correlations, and dependencies that contribute to a generating the proposal machine-learning model 128. These algorithms can extract valuable insights from various sources, including identifying keyword sets 120 and proposal categories 124 as function of the proposal machine-learning model 128. By applying machine learning techniques, the software can generate the proposal machine-learning model 128 extremely accurately. Machine learning models may enable the software to learn from past iterations of proposal machine-learning model 128 iteratively improve its training data over time.

With continued reference to FIG. 1, the proposal machine-learning model 128 may include a proposal classifier which may be consistent with classifier as described herein below in FIG. 2. The proposal machine-learning model 128 may be used to classify keyword sets 120 into proposal categories 124. This classification process may be a strategic step towards structuring the otherwise unstructured RFPs 112. By leveraging the capabilities of this model, the system can automatically analyze and understand the content and context of various textual data, assigning them to the most relevant categories based on their characteristics and themes. This approach not only facilitates the organization of vast amounts of data but also enhances the accessibility and manageability of the information contained within the raw datasets. The use of such a machine-learning model exemplifies the application of advanced technology to bring order and efficiency to data processing, making it possible to extract meaningful insights from large collections of unstructured data efficiently. Proposal classifier may, in some embodiments, include a clustering algorithm. In some embodiments, proposal classifier may be trained using unsupervised learning. In some embodiments, proposal classifier may be trained using supervised learning. In some embodiments, proposal classifier may be trained using proposal classifier training data.

With continued reference to FIG. 1, processor 104 is configured to assign one or more proposal codes 132 to each implicit data object 116 of the set of implicit data objects. As used in the current disclosure, a “proposal code” is an identifier used to classify data within an RFP or an RFP as a whole to a category. A proposal code 132 may be used to identify the industry and capabilities required for the RFP 112. This practice may be useful for organizing and managing the vast array of data that can accumulate when multiple RFPs are issued. A proposal code 132 may serve as a unique classification tool, similar in function to industry classification codes. A non-limiting example of a proposal code is the use of a NAICS code. NAICS, which stands for North American Industry Classification System, provides standardized codes to categorize industries according to their primary economic activities. Tagging an implicit data object 116 with an NAICS code as a proposal code 132 can effectively classify the data within the RFP, This may include identifying RFP's 112 target industry, helping to ensure that it reaches vendors whose capabilities and services align with the specific requirements of the project. For instance, if an implicit data object 116 identifies that the RFP 112 is targeting construction services, the NAICS code for ‘Construction’ can be used as a proposal code to streamline the process of identifying suitable vendors who operate within this specific industry sector.

With continued reference to FIG. 1, the proposal code 132 may be used to categorize implicit data objects 116 based on the required business activities and capabilities. This categorization may aid in streamlining the evaluation process by allowing the processor to quickly filter and sort implicit data objects 116 according to relevant criteria. For example, if an implicit data object 116 specifies a requirement for technical expertise or industry experience, the implicit data object 116 can be grouped and reviewed based on its respective proposal code that highlights these qualifications. Further, this may help in maintaining an organized database of implicit data objects 116, which can be particularly useful for large organizations or government bodies that handle numerous projects and need to access historical data quickly for comparison or compliance purposes. Each proposal code 132 may effectively tag an implicit data object 116 with key data about the targeted industry sector and required capabilities, making it easier to retrieve and analyze RFP information for future projects or ongoing contract management. Additionally, by assigning these identifiers, processor 104 may enable a more efficient matchmaking process between project requirements and vendor capabilities. This system ensures that only the most relevant implicit data objects 116 are considered for specific projects, reducing the time and resources spent on assessing unsuitable candidates. It may also facilitate a more targeted communication strategy, where follow-ups and clarifications can be directed more precisely based on the identified needs and capabilities. In an embodiment, a proposal code 132 may be a numerical code or an alphanumeric code. These codes may be anywhere from 1 to 100 characters.

With continued reference to FIG. 1, proposal codes 132 may be applied to implicit data objects 116 based on the proposal requirements of the project and the sectors involved. These identifiers generally serve to categorize implicit data objects 116 in a way that simplifies the assessment and selection process. Examples of proposal codes may include industry sector, capability level, technology expertise, certification status, geographical location, special designations, past performance ratings, and the like. In an embodiment, processor 104 may assign an implicit data object 116 a proposal code 132 according to the primary industry targeted by the RFP, such as ‘Construction,’ ‘IT Services,’ ‘Healthcare,’ ‘Education,’ and the like. In an additional embodiment, processor 104 may assign an implicit data object 116 a proposal code 132 according to the required capacity or scale of operations, such as ‘Small Scale,’ ‘Medium Scale,’ or ‘Large Scale.’ This helps in aligning project requirements with the appropriate vendor capabilities. In a third embodiment, processor 104 may assign an implicit data object 116 a proposal code 132 according to special designations; identifiers such as ‘Minority-Owned,’ ‘Veteran-Owned,’ ‘Women-Owned,’ or ‘Eco-Friendly’ could be important for projects that aim to support specific business groups or adhere to particular social responsibility criteria.

With continued reference to FIG. 1, processor 104 may tag implicit data objects 116 with proposal codes 132. The processor 104 may analyze the data contained within each implicit data object 116, which includes various aspects such as the targeted industry sector, required technological capabilities, necessary certifications, geographical location, and scale of operations. This may include the evaluation of a tokenized version of the implicit data object 116 or RFP 112. In an embodiment, implicit data object 116 and/or RFP 112 may be analyzed/processed using any NLP techniques discussed herein. Using predefined criteria that align with the project's proposal requirements, processor 104 may map these data points to corresponding proposal codes 132. For example, if an implicit data object 116 indicates that the project requires services within the healthcare sector and vendors must possess ISO certifications, the processor may assign identifiers like “Healthcare” and “ISO Certified.” Similarly, if the RFP highlights requirements for cloud computing services, the identifier “Cloud Computing Services” might be applied. The tagging process may involve both automated and rule-based logic, where the processor uses algorithms to parse the text and data within each RFP, extracting key information and matching it to the relevant identifiers. This could involve natural language processing, as discussed herein above, to understand descriptions of required capabilities and services or simple keyword matching for clearer metrics like certifications and location. Once the relevant information is extracted, it is categorized under the appropriate proposal codes, which are then attached to the RFP as tags. These tags not only summarize the key requirements of the project but also facilitate quick sorting and filtering of RFPs based on specific project criteria.

With continued reference to FIG. 1, processor 104 is designed to link implicit data objects 116 to proposal codes 132 within a data structure, enhancing the functionality and efficiency of handling multiple RFPs (Request for Proposals). An implicit data object 116 may be identified from the unstructured data of an RFP 112. This object may contain key information relevant to the RFP but is not initially marked or recognized as such. Processor 104 may use sophisticated algorithms to detect these implicit data objects and assigns them proposal codes 132 that categorize the data based on industry relevance and specific requirements. The linkage between implicit data objects and proposal codes may be managed within a structured data environment where each implicit data object 116 is paired with a corresponding proposal code 132. This pairing may be stored in a database or a similar data management system, allowing for easy access and manipulation. The structured data environment may support the retrieval of categorized RFP information, simplifies the evaluation process by grouping similar requirements, and enhances the accuracy of matching vendor capabilities with project demands. Furthermore, the assignment of proposal codes to implicit data objects by processor 104 may be dynamically adjustable based on the specific requirements and nuances of each RFP, allowing for a flexible and responsive system that can adapt to changing needs and detailed project requirements.

With continued reference to FIG. 1, a proposal code 132 may include a hierarchical proposal code. As used in the current disclosure, a “hierarchical proposal code” is a type of classification system used to tag data in a structured, layered manner. This may allow for a more nuanced categorization based on various levels of detail. This system arranges identifiers in a hierarchy from broad to specific, similar to how a taxonomy organizes concepts. At the top level, the identifier might denote a broad category such as the industry sector—e.g., ‘Technology’, ‘Healthcare’, or ‘Construction’. Subsequent levels would break down these broad categories into more specific sub-categories. For example, under the ‘Technology’ umbrella, you could have second-level identifiers like ‘Software Development’, ‘Hardware Manufacturing’, or ‘IT Services’, and these could be further divided into even more specific areas such as ‘Mobile App Development’, ‘Server Hardware’, or ‘Cybersecurity Solutions’. The purpose of using hierarchical proposal codes may be to provide a detailed and scalable method of organizing RFP information that can accommodate varying levels of data granularity. This approach may allow processor 104 to not only perform broad matches between RFP requirements and vendor capabilities but also to refine these matches by drilling down into more detailed aspects of the project's needs. By structuring identifiers in this hierarchical manner, the system may manage a wide range of RFPs, from generalist to highly specialized projects, and improve the precision of matching RFPs to vendors that fit their specific requirements and capabilities.

With continued reference to FIG. 1, processor 104 assigns proposal codes 132 to each RFP 112 using a code machine-learning model 136. As used in the current disclosure, a “code machine-learning model” is a machine-learning model that is configured to generate proposal codes 132. Code machine-learning model 136 may be consistent with the machine-learning model described below in FIG. 2. Inputs to the code machine-learning model 136 may include implicit data objects 116, RFP 112, examples of proposal codes 132, and the like. Outputs to the code machine-learning model 136 may include proposal codes 132 tailored to the implicit data objects 116. Code training data may include a plurality of data entries containing a plurality of inputs that are correlated to a plurality of outputs for training a processor by a machine-learning process. In an embodiment, code training data may include a plurality of implicit data objects 116 correlated to examples of proposal codes 132. Code training data may be received from database 300. Code training data may contain information about implicit data objects 116, RFP 112, examples of proposal codes 132, and the like. Examples of code training data may include technical manuals, historical RFPs. In an embodiment, code training data may be iteratively updated as a function of the input and output results of past code machine-learning model 136 or any other machine-learning model mentioned throughout this disclosure. The machine-learning model may be performed using, without limitation, linear machine-learning models such as without limitation logistic regression and/or naive Bayes machine-learning models, nearest neighbor machine-learning models such as k-nearest neighbors machine-learning models, support vector machines, least squares support vector machines, fisher's linear discriminant, quadratic machine-learning models, decision trees, boosted trees, random forest machine-learning model, and the like.

With continued reference to FIG. 1, code training data may be used to train an LLM. Code training data may include text passages with embedded data points marked for the model to learn their contextual relevance. In a non-limiting example, consider a passage from a business report: “In Q4, Acme Corp observed a revenue surge in Southeast Asia, notably in Thailand and Vietnam, thanks to robust sales. The initiative started early March is on track, targeting a mid-September launch. Key contributors include Project Manager John Doe and Lead Engineer Jane Smith.” In the Code training data, geographical markers such as “Thailand” and “Vietnam” would be tagged as ‘Geographical Markers’, dates like “early March” and “mid-September” as ‘Temporal References’, and names “John Doe” and “Jane Smith” as ‘Stakeholder Information’. Such annotations help an LLM or BERT learn to detect these implicit data objects 116 even when they are not explicitly categorized in the raw text. An encoder such as without limitation a BERT, may process this input, embedding it into a higher-dimensional space where similar examples are positioned closer together, facilitating the model's ability to generalize from specific annotations to broader applications in unseen texts, or otherwise generating an embedding such as a vector representing a code. This approach ensures that the model not only recognizes these elements but understands their relevance in various contexts.

With continued reference to FIG. 1, the code machine-learning model 136 may be configured to assign proposal codes 132 to each request for proposal (RFP) 112 within a plurality of RFPs. The code machine-learning model 136 may operate by processing textual data from RFPs using natural language processing (NLP) techniques, which may include tokenization, normalization, and semantic analysis to understand the context and key requirements of each RFP. The code machine-learning model 136 may first preprocess the text of an RFP 112 to extract implicit data objects 116 relevant to proposal coding. This preprocessing may involve the extraction of keywords, phrases, and contextual relationships within the RFP text. Based on the implicit data objects 116, the model may apply a classification algorithm to assign a proposal code 132. The classification may be based on a trained dataset that includes numerous examples of implicit data objects 116 with manually assigned proposal codes. The model learns to recognize patterns and correlations between the text features and the appropriate proposal codes, enabling it to predict the most suitable code for new RFPs. The code machine-learning model 136 may utilize a variety of machine learning algorithms, such as support vector machines (SVM), decision trees, or neural networks, to perform the classification task. The choice of algorithm may depend on the complexity of the classification and the characteristics of the training data. For instance, if the proposal codes require distinguishing subtle nuances between similar categories, a more complex model like a deep neural network may be employed to capture these subtleties effectively. In some embodiments, the code machine-learning model 136 may also include features that allow for dynamic adjustment of the classification criteria based on evolving business needs or external factors such as changes in market conditions or regulatory requirements. This adaptive capability ensures that the proposal coding remains relevant and aligned with current organizational strategies and industry standards.

With continued reference to FIG. 1, once a proposal code 132 is assigned to an implicit data objects 116, the processor 104 may store this information in a database 300, where it can be used to facilitate the management and sorting of RFPs and/or implicit data objects 116 according to their categorized codes. This automated categorization helps streamline the evaluation process, allowing profiles 108 to quickly identify and focus on implicit data objects 116 that match specific criteria, thus improving efficiency in handling and responding to requests. Furthermore, the code machine-learning model 136 may continuously improve its accuracy and efficiency as more data is processed and as feedback from the classification outcomes is integrated back into the model, a process known as machine learning retraining or model updating.

Still referring to FIG. 1, the code machine learning model 136 may include a large language model (LLM). A “large language model,” as used herein, is a deep learning data structure that can recognize, summarize, translate, predict and/or generate text and other content based on knowledge gained from massive datasets. Large language models may be trained on large sets of data. Training sets may be drawn from diverse sets of data such as, as non-limiting examples, novels, blog posts, articles, emails, unstructured data, electronic records, and the like. In some embodiments, training sets may include a variety of subject matters, such as, as nonlimiting examples, RFPs 112, Submissions, documents, inventory records, personnel records, business documents, emails, user communications, and the like. In some embodiments, training sets of an LLM may include information from one or more public or private databases. As a non-limiting example, training sets may include databases associated with an entity. In some embodiments, training sets may include portions of documents associated with the implicit data objects 116 correlated to examples of outputs. In an embodiment, an LLM may include one or more architectures based on capability requirements of an LLM. Exemplary architectures may include, without limitation, GPT (Generative Pretrained Transformer), BERT (Bidirectional Encoder Representations from Transformers), T5 (Text-To-Text Transfer Transformer), and the like. Architecture choice may depend on a needed capability such generative, contextual, or other specific capabilities.

With continued reference to FIG. 1, in some embodiments, an LLM may be generally trained. As used in this disclosure, a “generally trained” LLM is an LLM that is trained on a general training set comprising a variety of subject matters, data sets, and fields. In some embodiments, an LLM may be initially generally trained. Additionally, or alternatively, an LLM may be specifically trained. As used in this disclosure, a “specifically trained” LLM is an LLM that is trained on a specific training set, wherein the specific training set includes data including specific correlations for the LLM to learn. As a non-limiting example, an LLM may be generally trained on a general training set, then specifically trained on a specific training set. In an embodiment, specific training of an LLM may be performed using a supervised machine learning process. In some embodiments, generally training an LLM may be performed using an unsupervised machine learning process. As a non-limiting example, specific training set may include information from a database. As a non-limiting example, specific training set may include text related to the users such as user specific data for electronic records correlated to examples of outputs. In an embodiment, training one or more machine learning models may include setting the parameters of the one or more models (weights and biases) either randomly or using a pretrained model. Generally training one or more machine learning models on a large corpus of text data can provide a starting point for fine-tuning on a specific task. A model such as an LLM may learn by adjusting its parameters during the training process to minimize a defined loss function, which measures the difference between predicted outputs and ground truth. Once a model has been generally trained, the model may then be specifically trained to fine-tune the pretrained model on task-specific data to adapt it to the target task. Fine-tuning may involve training a model with task-specific training data, adjusting the model's weights to optimize performance for the particular task. In some cases, this may include optimizing the model's performance by fine-tuning hyperparameters such as learning rate, batch size, and regularization. Hyperparameter tuning may help in achieving the best performance and convergence during training. In an embodiment, fine-tuning a pretrained model such as an LLM may include fine-tuning the pretrained model using Low-Rank Adaptation (LoRA). As used in this disclosure, “Low-Rank Adaptation” is a training technique for large language models that modifies a subset of parameters in the model. Low-Rank Adaptation may be configured to make the training process more computationally efficient by avoiding a need to train an entire model from scratch. In an exemplary embodiment, a subset of parameters that are updated may include parameters that are associated with a specific task or domain.

With continued reference to FIG. 1, in some embodiments an LLM may include and/or be produced using Generative Pretrained Transformer (GPT), GPT-2, GPT-3, GPT-4, and the like. GPT, GPT-2, GPT-3, GPT-3.5, and GPT-4 are products of Open AI Inc., of San Francisco, CA. An LLM may include a text prediction-based algorithm configured to receive an article and apply a probability distribution to the words already typed in a sentence to work out the most likely word to come next in augmented articles. For example, if some words that have already been typed are “The vendor must have at least 100 qualified employees at the start of the”, then it may be highly likely that the word “contract” will come next. An LLM may output such predictions by ranking words by likelihood or a prompt parameter. For the example given above, an LLM may score “you” as the most likely, “your” as the next most likely, “his” or “her” next, and the like. An LLM may include an encoder component and a decoder component.

Still referring to FIG. 1, an LLM may include a transformer architecture. In some embodiments, encoder component of an LLM may include transformer architecture. A “transformer architecture,” for the purposes of this disclosure is a neural network architecture that uses self-attention and positional encoding. Transformer architecture may be designed to process sequential input data, such as natural language, with applications towards tasks such as translation and text summarization. Transformer architecture may process the entire input all at once. “Positional encoding,” for the purposes of this disclosure, refers to a data processing technique that encodes the location or position of an entity in a sequence. In some embodiments, each position in the sequence may be assigned a unique representation. In some embodiments, positional encoding may include mapping each position in the sequence to a position vector. In some embodiments, trigonometric functions, such as sine and cosine, may be used to determine the values in the position vector. In some embodiments, position vectors for a plurality of positions in a sequence may be assembled into a position matrix, wherein each row of position matrix may represent a position in the sequence.

With continued reference to FIG. 1, an LLM and/or transformer architecture may include an attention mechanism. An “attention mechanism,” as used herein, is a part of a neural architecture that enables a system to dynamically quantify the relevant features of the input data. In the case of natural language processing, input data may be a sequence of textual elements. It may be applied directly to the raw input or to its higher-level representation.

With continued reference to FIG. 1, attention mechanism may represent an improvement over a limitation of an encoder-decoder model. An encoder-decider model encodes an input sequence to one fixed length vector from which the output is decoded at each time step. This issue may be seen as a problem when decoding long sequences because it may make it difficult for the neural network to cope with long sentences, such as those that are longer than the sentences in the training corpus. Applying an attention mechanism, an LLM may predict the next word by searching for a set of positions in a source sentence where the most relevant information is concentrated. An LLM may then predict the next word based on context vectors associated with these source positions and all the previously generated target words, such as textual data of a dictionary correlated to a prompt in a training data set. A “context vector,” as used herein, are fixed-length vector representations useful for document retrieval and word sense disambiguation.

Still referring to FIG. 1, attention mechanism may include, without limitation, generalized attention self-attention, multi-head attention, additive attention, global attention, and the like. In generalized attention, when a sequence of words or an image is fed to an LLM, it may verify each element of the input sequence and compare it against the output sequence. Each iteration may involve the mechanism's encoder capturing the input sequence and comparing it with each element of the decoder's sequence. From the comparison scores, the mechanism may then select the words or parts of the image that it needs to pay attention to. In self-attention, an LLM may pick up particular parts at different positions in the input sequence and over time compute an initial composition of the output sequence. In multi-head attention, an LLM may include a transformer model of an attention mechanism. Attention mechanisms, as described above, may provide context for any position in the input sequence. For example, if the input data is a natural language sentence, the transformer does not have to process one word at a time. In multi-head attention, computations by an LLM may be repeated over several iterations, each computation may form parallel layers known as attention heads. Each separate head may independently pass the input sequence and corresponding output sequence element through a separate head. A final attention score may be produced by combining attention scores at each head so that every nuance of the input sequence is taken into consideration. In additive attention (Bahdanau attention mechanism), an LLM may make use of attention alignment scores based on a number of factors. Alignment scores may be calculated at different points in a neural network, and/or at different stages represented by discrete neural networks. Source or input sequence words are correlated with target or output sequence words but not to an exact degree. This correlation may take into account all hidden states and the final alignment score is the summation of the matrix of alignment scores. In global attention (Luong mechanism), in situations where neural machine translations are required, an LLM may either attend to all source words or predict the target sentence, thereby attending to a smaller subset of words.

With continued reference to FIG. 1, multi-headed attention in encoder may apply a specific attention mechanism called self-attention. Self-attention allows models such as an LLM or components thereof to associate each word in the input, to other words. As a non-limiting example, an LLM may learn to associate the word “you,” with “how” and “are.” It's also possible that an LLM learns that words structured in this pattern are typically a question and to respond appropriately. In some embodiments, to achieve self-attention, input may be fed into three distinct fully connected neural network layers to create query, key, and value vectors. Query, key, and value vectors may be fed through a linear layer; then, the query and key vectors may be multiplied using dot product matrix multiplication in order to produce a score matrix. The score matrix may determine the amount of focus for a word should be put on other words (thus, each word may be a score that corresponds to other words in the time-step). The values in score matrix may be scaled down. As a non-limiting example, score matrix may be divided by the square root of the dimension of the query and key vectors. In some embodiments, the softmax of the scaled scores in score matrix may be taken. The output of this softmax function may be called the attention weights. Attention weights may be multiplied by your value vector to obtain an output vector. The output vector may then be fed through a final linear layer.

Still referencing FIG. 1, in order to use self-attention in a multi-headed attention computation, query, key, and value may be split into N vectors before applying self-attention. Each self-attention process may be called a “head.” Each head may produce an output vector and each output vector from each head may be concatenated into a single vector. This single vector may then be fed through the final linear layer discussed above. In theory, each head can learn something different from the input, therefore giving the encoder model more representation power.

With continued reference to FIG. 1, encoder of transformer may include a residual connection. Residual connection may include adding the output from multi-headed attention to the positional input embedding. In some embodiments, the output from residual connection may go through a layer normalization. In some embodiments, the normalized residual output may be projected through a pointwise feed-forward network for further processing. The pointwise feed-forward network may include a couple of linear layers with a ReLU activation in between. The output may then be added to the input of the pointwise feed-forward network and further normalized.

Continuing to refer to FIG. 1, transformer architecture may include a decoder. Decoder may a multi-headed attention layer, a pointwise feed-forward layer, one or more residual connections, and layer normalization (particularly after each sub-layer), as discussed in more detail above. In some embodiments, decoder may include two multi-headed attention layers. In some embodiments, decoder may be autoregressive. For the purposes of this disclosure, “autoregressive” means that the decoder takes in a list of previous outputs as inputs along with encoder outputs containing attention information from the input.

With further reference to FIG. 1, in some embodiments, input to decoder may go through an embedding layer and positional encoding layer in order to obtain positional embeddings. Decoder may include a first multi-headed attention layer, wherein the first multi-headed attention layer may receive positional embeddings.

With continued reference to FIG. 1, first multi-headed attention layer may be configured to not condition to future tokens. As a non-limiting example, when computing attention scores on the word “am,” decoder should not have access to the word “fine” in “I am fine,” because that word is a future word that was generated after. The word “am” should only have access to itself and the words before it. In some embodiments, this may be accomplished by implementing a look-ahead mask. Look ahead mask is a matrix of the same dimensions as the scaled attention score matrix that is filled with “0s” and negative infinities. For example, the top right triangle portion of look-ahead mask may be filled with negative infinities. Look-ahead mask may be added to scaled attention score matrix to obtain a masked score matrix. Masked score matrix may include scaled attention scores in the lower-left triangle of the matrix and negative infinities in the upper-right triangle of the matrix. Then, when the softmax of this matrix is taken, the negative infinities will be zeroed out; this leaves zero attention scores for “future tokens.”

Still referring to FIG. 1, second multi-headed attention layer may use encoder outputs as queries and keys and the outputs from the first multi-headed attention layer as values. This process matches the encoder's input to the decoder's input, allowing the decoder to decide which encoder input is relevant to put a focus on. The output from second multi-headed attention layer may be fed through a pointwise feedforward layer for further processing.

With continued reference to FIG. 1, the output of the pointwise feedforward layer may be fed through a final linear layer. This final linear layer may act as a classifier. This classifier may be as big as the number of classes that you have. For example, if you have 10,000 classes for 10,000 words, the output of that classifier will be of size 10,000. The output of this classifier may be fed into a softmax layer which may serve to produce probability scores between zero and one. The index may be taken of the highest probability score in order to determine a predicted word.

Still referring to FIG. 1, decoder may take this output and add it to the decoder inputs. Decoder may continue decoding until a token is predicted. Decoder may stop decoding once it predicts an end token.

Continuing to refer to FIG. 1, in some embodiment, decoder may be stacked N layers high, with each layer taking in inputs from the encoder and layers before it. Stacking layers may allow an LLM to learn to extract and focus on different combinations of attention from its attention heads.

With continued reference to FIG. 1, an LLM may receive an input. Input may include a string of one or more characters. Inputs may additionally include unstructured data. For example, input may include one or more words, a sentence, a paragraph, a thought, a query, and the like. A “query” for the purposes of the disclosure is a string of characters that poses a question. In some embodiments, input may be received from a user device. User device may be any computing device that is used by a user. As non-limiting examples, user device may include desktops, laptops, smartphones, tablets, and the like. In some embodiments, input may include any set of data associated with RFPs 112 and/or implicit data objects 116.

With continued reference to FIG. 1, an LLM may generate at least one annotation as an output. At least one annotation may be any annotation as described herein. In some embodiments, an LLM may include multiple sets of transformer architecture as described above. Output may include a textual output. A “textual output,” for the purposes of this disclosure is an output comprising a string of one or more characters. Textual output may include, for example, a plurality of annotations for unstructured data. In some embodiments, textual output may include a phrase or sentence identifying the status of a user query. In some embodiments, textual output may include a sentence or plurality of sentences describing a response to a user query. As a non-limiting example, this may include restrictions, timing, advice, dangers, benefits, and the like.

With continued reference to FIG. 1, processor 104 may structure the unstructured text with a LLM, such as BERT. The LLM may be used to encode words and phrases into vectors, known as embeddings. These embeddings may transform the raw textual data into a format where each vector can be associated with specific codes or identifiers that represent various implicit data objects within the text. For example, BERT could generate embeddings for geographical names like “Thailand” and “Vietnam,” and associate these with geographical codes. Similarly, names such as “John Doe” and “Jane Smith” could be linked to stakeholder codes. As mentioned herein above, the LLM may output these associations as annotations, which are then attached to the text, providing a layer of structured data over the raw unstructured input. This output might not only include specific data point annotations but could also extend to textual responses to queries posed to the system, encompassing a wide range of information such as advice, timing, restrictions, and more. These outputs, composed of one or more character strings, may enrich the original text by making implicit data explicit and accessible for further processing and analysis. This approach significantly enhances the utility of the LLM in extracting and leveraging hidden information from unstructured texts, thereby facilitating more informed decision-making and analysis.

With continued reference to FIG. 1, machine learning may play a crucial role in enhancing the function of software for generating a code machine-learning model 136. This may include identifying patterns within the set of implicit data objects 116 that lead to changes in the capabilities of the code machine-learning model 136. By analyzing vast amounts of data related to implicit data objects 116, machine learning algorithms can identify patterns, correlations, and dependencies that contribute to the generation of code machine-learning model 136. These algorithms can extract valuable insights from various sources, including text, document, RFPs, historical submissions, accepted submissions, rejected submissions, and the like. By applying machine learning techniques, the software can assign proposal codes 132 by analyzing implicit data objects 116 extremely accurately and quickly. Machine learning models may enable the software to learn from past collaborative experiences of the entities and iteratively improve its training data over time.

With continued reference to FIG. 1, processor 104 may be configured to update the code training data of the code machine-learning model 136 using user inputs. A code machine-learning model 136 may use user input to update its training data, thereby improving its performance, speed, and accuracy. In embodiments, the code machine-learning model 136 may be iteratively updated using input and output results of past iterations of the code machine-learning model 136. The code machine-learning model 136 may then be iteratively retrained using the updated code training data. For instance, and without limitation, code machine-learning model 136 may be trained using a first training data from, for example, and without limitation, training data from a user input or database. The code machine-learning model 136 may then be updated by using previous inputs and outputs from the code machine-learning model 136 as second set of training data to then retrain a newer iteration of code machine-learning model 136. This process of updating the code machine-learning model 136 and its associated training data may be continuously done to create an improved code machine-learning model 136. When users interact with the software, their actions, preferences, and feedback provide valuable information that can be used to refine and enhance the model. This user input is collected and incorporated into the training data, allowing the machine learning model to learn from real-world interactions and adapt its predictions accordingly. By continually incorporating user input, the model becomes more responsive to user needs and preferences, capturing evolving trends and patterns. This iterative process of updating the training data with user input enables the machine learning model to deliver more personalized and relevant results, ultimately enhancing the overall user experience. The discussion within this paragraph may apply to both the code machine-learning model 136 and any other machine-learning model/classifier discussed herein.

Incorporating the user feedback may include updating the training data by removing or adding correlations of user data to a path or resources as indicated by the feedback. Any machine-learning model as described herein may have the training data updated based on such feedback or data gathered using any method described herein. For example, when correlations in training data are based on outdated information, a web crawler may update such correlations based on more recent resources and information.

With continued reference to FIG. 1, processor 104 may use user feedback to train the machine-learning models and/or classifiers described above. For example, machine-learning models and/or classifiers may be trained using past inputs and outputs of the machine-learning model. In some embodiments, if user feedback indicates that an output of machine-learning models and/or classifiers was “unfavorable,” then that output and the corresponding input may be removed from training data used to train machine-learning models and/or classifiers, and/or may be replaced with a value entered by, e.g., another value that represents an ideal output given the input the machine learning model originally received, permitting use in retraining, and adding to training data; in either case, machine-learning models may be retrained with modified training data as described in further detail below. In some embodiments, training data of classifier may include user feedback.

With continued reference to FIG. 1, in some embodiments, an accuracy score may be calculated for the machine-learning model and/or classifier using user feedback. For the purposes of this disclosure, “accuracy score,” is a numerical value concerning the accuracy of a machine-learning model. For example, the accuracy/quality of the output code machine-learning model 136 may be averaged to determine an accuracy score. In some embodiments, an accuracy score may be determined for pairing of entities. Accuracy score or another score as described above may indicate a degree of retraining needed for a machine-learning model and/or classifier. Processor 104 may perform a larger number of retraining cycles for a higher number (or lower number, depending on a numerical interpretation used), and/or may collect more training data for such retraining. The discussion within this paragraph and the paragraphs preceding this paragraph may apply to both the code machine-learning model 136 and/or any other machine-learning model/classifier mentioned herein.

With continued reference to FIG. 1, processor 104 may be configured to generate a submission 140 for each profile 108 of the plurality of profiles 108 as a function of the set of implicit data objects 116. Within the current disclosure, a “submission” is set of structured data that a vendor submits or has submitted in response to a Request for Proposal (RFP). Each submission 140 may be tailored to meet the specific set of implicit data objects 116 generated from the RFP 112 and is generated based on the details provided in the vendor's profile. The submission may include a plurality of information that is provided by the profile 108. This may include information that showcases the vendor's capabilities, methodology, compliance with the requested criteria, and their plan to meet or exceed the project's expectations. Submission 140 may encompass technical descriptions, pricing details, timelines, team qualifications, and other relevant data that align with the RFP's requirements.

With continued reference to FIG. 1, a submission 140 may be designed to effectively communicate the vendor's readiness and suitability for the project by including detailed technical descriptions that explain the proposed solutions or services, precise pricing details that outline the financial proposal, clear timelines that project completion phases, and extensive qualifications of the team designated to execute the project. Additionally, the submission may incorporate supplementary data that supports the vendor's claims, such as case studies, references, proof of concept, certifications, and any other documents that reinforce the vendor's ability to meet the RFP's demands. This compilation may ensure that the submission not only meets the evaluation criteria but also positions the vendor as a strong candidate by clearly demonstrating their capabilities and understanding of the project requirements. Through this systematic approach, the processor 104 aids vendors in constructing robust and competitive submissions that are tailor-made to address the nuances of the RFP, facilitating a more efficient and effective selection process.

With continued reference to FIG. 1, processor 104 may convert unstructured or semi-structured profile 108 into a structured and cohesive submission 140. To generate a submission 140, processor 104 may parse the profile 108 to categorize and organize the data into a structured format that aligns with the specific implicit data objects 116 stipulated in the RFP 112. Processor 104 may extract key pieces of information from the profile 108, which includes identifying and segregating relevant data points such as financial data, operational metrics, or compliance information that are pertinent to the RFP. The extracted data may then undergo a normalization process to standardize the information for ease of comparison and assessment. This could involve converting all financial figures to a single currency, standardizing date formats, or unifying terminology across the dataset. Processor 104 may then integrate the normalized data into a coherent format. This step may be crucial as it compiles the data into a structured document or series of documents that systematically address each aspect of the implicit data objects 116. For example, technical capabilities might be grouped together, followed by financial stability indicators, then project timelines, and finally, compliance certifications. In an embodiment, using NLP techniques, the processor may identify key phrases and keywords within the unstructured data that match the language or specific requirements of the RFP. This helps in highlighting the vendor's capabilities that are directly relevant to the RFP's criteria. Based on the structure dictated by the RFP 112, processor 104 may assemble the data into a formal submission document. This document may be crafted to ensure it flows logically, covering all necessary sections such as executive summary, technical proposal, financial proposal, compliance statements, and any additional supporting documentation.

With continued reference to FIG. 1, processor 104 may generate submission 140 using a submission machine-learning model. As used in the current disclosure, a “submission machine-learning model” is a machine-learning model that is configured to generate submission 140. Submission machine-learning model may be consistent with the machine-learning model described below in FIG. 2. Inputs to the submission machine-learning model may include implicit data objects 116, profile 108, examples of submission 140, and the like. Outputs to the submission machine-learning model may include submission 140 tailored to the implicit data objects 116 and profile 108. Submission training data may include a plurality of data entries containing a plurality of inputs that are correlated to a plurality of outputs for training a processor by a machine-learning process. In an embodiment, submission training data may include a plurality of implicit data objects 116 and profile 108 correlated to examples of submission 140. Submission training data may be received from database 300. Submission training data may contain information about implicit data objects 116, profile 108, examples of submission 140, and the like. In an embodiment, submission training data may be iteratively updated as a function of the input and output results of past submission machine-learning model or any other machine-learning model mentioned throughout this disclosure. The machine-learning model may be performed using, without limitation, linear machine-learning models such as without limitation logistic regression and/or naive Bayes machine-learning models, nearest neighbor machine-learning models such as k-nearest neighbors machine-learning models, support vector machines, least squares support vector machines, fisher's linear discriminant, quadratic machine-learning models, decision trees, boosted trees, random forest machine-learning model, and the like.

With continued reference to FIG. 1, processor 104 may be configured to identify submission data as a function of the profile 108 and implicit data objects 116. As used in the current disclosure, “submission data” refers to specific information that is essential to meet the criteria outlined in the implicit data objects 116 of an RFP but is not already included or available in the profile 108. Processor 104 may be configured to identify such gaps by analyzing the data contained in the profile against the checklist of requirements specified in the RFP. This configuration enables the processor to pinpoint what critical information needs to be acquired or generated to complete the submission adequately. Processor 104 may first review the contents of the profile 108, which contains a comprehensive collection of data about the vendor, including their business operations, financial status, capabilities, etc. It may then cross-reference this information with the implicit data objects 116, which detail the specific data needed for a vendor to qualify as a potential supplier or partner as per the RFP. Through a systematic analysis, the processor may identify discrepancies or missing elements that are necessary to fulfill the implicit data objects 116 but are absent in the profile 108. This could include specific technical capabilities, certifications, past project experiences, or other compliance-related data that the RFP requires. Once gaps are identified, the processor 104 may tag these data points as “submission data.” This tagging helps in categorizing which pieces of information are missing and prioritizing their collection based on the impact they have on meeting the RFP's criteria. In an embodiment, processor 104 may be programmed to notify the vendor of these gaps, providing a list of missing data. Additionally, it may suggest methods for acquiring such data, whether through internal assessments, external consultations, or by updating the profile with the required information.

With continued reference to FIG. 1, processor 104 may employ a web crawler to retrieve identified submission data that is missing from the profile 108 but required by the implicit data objects 116. A web crawler, as described herein above, may be a software application designed to systematically browse the internet and gather information from websites according to specific criteria. Once the missing submission data is identified, processor 104 may instruct the web crawler to target specific types of data. This could include technical specifications, industry certifications, pricing information, technological capabilities, regulatory compliance data relevant to the vendor, employee, or owner demographic data, and the like. The processor 104 may determine potential sources where the required data might be found. This includes public databases, industry publications, official regulatory bodies' websites, trade associations, and potentially the vendor's own website or digital presence. Once the web crawler has been seeded, processor 104 may set up the web crawler with specific keywords, URLs, and search parameters related to the identified data gaps. The crawler is also programmed with algorithms to navigate through web pages, follow links, and respect the robots.txt files to ensure ethical scraping practices. As the web crawler traverses the web, it may use techniques like HTML parsing, API calls, or even machine learning models to identify, extract, and collect data that matches the predefined criteria. This data is then extracted from web pages and stored in a structured format for further processing. In an embodiment, the extracted data may require cleaning and validation to ensure it is accurate, relevant, and usable. Processor 104 may apply data cleaning techniques to remove duplicates, correct errors, and format the data consistently. Validation checks may also be performed to ensure the data meets the specific requirements of the RFP. Once the data is cleaned and validated, it may be integrated into the profile 108 or directly into the submission 140 document. Processor 104 may use this updated information to fill the gaps in the proposal, ensuring that all requirements of the RFP are met comprehensively.

With continued reference to FIG. 1, processor 104 is configured to generate a vendor score 144 for each profile 108 as a function of a comparison of each profile 108 to the one or more proposal codes 132. As used in the current disclosure, a “vendor score” is a score used to quantify how well a profile 108 aligns with one or more proposal codes 132. This score may be generated through a systematic comparison of each submission 140 against the defined criteria, aiming to objectively quantify the degree to which the vendor meets or exceeds the expectations set out in the implicit data objects. Processor 104 may review each profile 108 by analyzing the information provided against each specific requirement listed in the implicit data objects 116. This may involve checking for completeness, accuracy, and relevance of the responses provided by the vendor. Each of the one or more proposal codes 132 may be weighed differently according to their importance to the overall project. Processor 104 may assign weights to different proposal codes 132 based on these priorities. The processor 104 may apply a scoring mechanism where points are awarded based on how well each section of the submission or profile 108 meets the associated requirements of the proposal codes 132. This can involve simple checklists for compliance, more complex scoring for degrees of alignment, or even sophisticated evaluations where innovative solutions or superior capabilities receive higher scores. A vendor score 144 may be generated for each implicit data object 116 of the plurality of implicit data objects 116. In an embodiment, vendor scores 144 for individual implicit data objects 116 or proposal codes 132 may be weighted then aggregated to form a comprehensive vendor score. This aggregation may consider the weighted importance of each criterion to ensure that more critical aspects of the proposal have a proportionately greater impact on the final score.

With continued reference to FIG. 1, the scoring mechanism applied by processor 104 to evaluate submissions 140/profiles 108 may be used to determine the adequacy and superiority of each submission 140 relative to the defined requirements. This mechanism may be designed to quantitatively and qualitatively assess how well each vendor meets the outlined criteria. At the foundational level, the mechanism might operate on a simple checklist basis, where basic compliance with mandatory requirements is checked off, and each compliant item receives a predefined number of points according to a weighted scale. This may ensure that all minimum standards are met by the profile 108/submission 140. Moving beyond mere compliance, the scoring mechanism may be more nuanced, allowing for graduated scoring that allocates points based on the degree of alignment between the vendor's offerings and the RFP's needs. In an embodiment, this may involve scoring scales where points increase as the solution proposed by the vendor exceeds basic requirements, demonstrating added value, superior efficiency, or innovative approaches that could significantly benefit the project. Such a method may not only identify profiles 108 that are compliant but also highlights those that go above and beyond the requirements. In some embodiments, weighted scoring may be used to comprehensively evaluate each submission 140. Processor 104 may assign different weights to various sections of the implicit data objects 116 based on their significance to the project's overall success. For example, if the project critically depends on cutting-edge technology, then technological criteria might carry more weight compared to other parameters like cost or lead time. This may ensure that the scoring reflects strategic priorities and that the highest scores are reserved for submissions that excel in the most critical areas.

With continued reference to FIG. 1, a vendor score 144 may be normalized to ensure that all evaluation criteria such as technical capabilities, financial stability, compliance adherence, and the like are brought onto a comparable scale. This normalization is crucial to eliminate any bias introduced by differing units or scales of measurement used in the evaluation process. Common normalization techniques might include min-max scaling, z-score normalization, or logarithmic transformation. In an embodiment, a vendor score 144 could be expressed as a numerical score, a linguistic value, or an alphabetical score. For example, numerically, the score might range from 0-1, 1-10, 1-100, 1-1000, where a score of 1 might indicate minimal alignment with RFP requirements and a score of 10 indicates a high degree of alignment. Linguistically, values could range from “Low Alignment” to “High Alignment.” Additionally, the vendor score 144 might also assess whether the impact of the vendor's proposal is positive or negative on the project's objectives. This could be represented by using negative values alongside positive values. For instance, in some embodiments, linguistic values might correspond to specific ranges on a numerical scale; a proposal scoring between 40-60 on a 1-100 scale could be labeled as having a “Moderate Alignment” with the project's goals.

With continued reference to FIG. 1, the comparison between each submission 140/profile 108 to proposal codes 132. The comparison may include both qualitative and quantitative assessments. Qualitatively, the processor may evaluate the textual and descriptive parts of the submission 140/profile 108 to determine how well the vendor fits the project's needs and how effectively their proposed solutions align with the goals and expectations set forth. Quantitatively, the processor may examine numerical data provided in the submission, such as budget estimates and timelines, checking for their realism and suitability given the project's scope and constraints. The processor may also utilize predefined scoring rubrics or algorithms that assign points or ratings based on the degree of alignment between the submission and each requirement. These tools consider not only the presence of required information but also the quality, depth, and relevance of the responses. For instance, a submission or profile 140 that not only meets the basic requirement but provides added value through innovative solutions or demonstrates superior capability in key areas might receive higher scores. After the comparison and scoring are complete, the processor 104 may aggregate the scores from each section to produce a comprehensive evaluation score for the submission. This score helps in ranking the submissions, allowing decision-makers to easily identify which proposals best meet the criteria specified in the RFP and thereby make more informed and objective decisions regarding vendor selection. This methodical approach ensures a thorough and fair comparison of each submission against the set implicit data objects, facilitating a transparent procurement process.

With continued reference to FIG. 1, processor 104 may utilize vendor scores 144 to rank each profile 108 as function of their submissions 140. This ranking process may begin after each submission 140 associated with the profiles 108 has been evaluated and assigned a vendor score 144. The ranking may be performed by sorting the vendor scores 144 in descending order, with the highest scores indicating the best alignment with the RFP's specifications and thus placing those vendors at the top of the list. The ranking process may serve multiple purposes. Primarily, it may provide a clear and organized way to visually depict which vendors are most likely to fulfill the project's requirements successfully and to the highest standards. This ranking may allow allows decision-makers to quickly identify top candidates for further consideration or direct negotiations. Moreover, it may streamline the selection process by systematically filtering out lower-scoring vendors who may not meet the necessary criteria, thereby focusing attention and resources on evaluating only the most promising submissions. Processor 104 might also use this ranking to engage in tiered or segmented decision-making processes. For example, the top-tier vendors might be invited to participate in a final round of presentations or detailed discussions, or they might be given preferential terms in negotiation processes due to their high ranking. This approach not only enhances the efficiency of the procurement process but also incentivizes vendors to submit highly competitive and comprehensive proposals. Additionally, the ranking system can be adjusted or recalibrated over time based on feedback from actual project outcomes, changes in project priorities, or shifts in strategic goals. Processor 104 can incorporate these changes into its evaluation algorithms to ensure that the ranking system remains relevant and effective in selecting the best vendors for future projects.

With continued reference to FIG. 1, processor 104 may generate vendor score 144 using a score machine-learning model. As used in the current disclosure, a “score machine-learning model” is a machine-learning model that is configured to generate vendor score 144. Score machine-learning model may be consistent with the machine-learning model described below in FIG. 2. Inputs to the score machine-learning model may include implicit data objects 116, profile 108, submission 140, examples of vendor score 144, and the like. Outputs to the score machine-learning model may include vendor score 144 tailored to the profiles 108 and proposal codes. Score training data may include a plurality of data entries containing a plurality of inputs that are correlated to a plurality of outputs for training a processor by a machine-learning process. In an embodiment, score training data may include a plurality of profiles 108 and proposal codes correlated to examples of vendor score 144. Score training data may be received from database 300. Score training data may contain information about implicit data objects 116, profile 108, submission 140, examples of vendor score 144, and the like. In an embodiment, score training data may be iteratively updated as a function of the input and output results of past score machine-learning model or any other machine-learning model mentioned throughout this disclosure. The machine-learning model may be performed using, without limitation, linear machine-learning models such as without limitation logistic regression and/or naive Bayes machine-learning models, nearest neighbor machine-learning models such as k-nearest neighbors machine-learning models, support vector machines, least squares support vector machines, fisher's linear discriminant, quadratic machine-learning models, decision trees, boosted trees, random forest machine-learning model, and the like.

With continued reference to FIG. 1, processor 104 may generate vendor score 144 using a score machine-learning model as a function of a comparison of each submission 140 or profile 108 to the proposal codes. The process may include training the machine-learning model on historical data sets that include examples of previous submissions and their outcomes. This training phase may involve feeding the model data about submissions that have successfully met or failed to meet similar requirements in the past, enabling it to learn and identify patterns and features that correlate with successful compliance. Once trained, processor 104 may use the machine-learning model to analyze new submissions 140 or profiles 108. Each submission 140 may be converted into a format that the model can process, which typically involves extracting and encoding features such as text responses, numerical data, and possibly encoded categorical data that represent the vendor's compliance with each of the implicit data objects 116. The machine-learning model may then evaluate these features to assess how well each submission 140 meets the implicit data objects 116 laid out in the RFP 112. The model may output a score for each submission 140, which quantifies the level of alignment between the vendor's proposal and the implicit data objects. This vendor score 144 might be based on a probability estimation from 0 to 1, where 1 indicates a perfect match to the RFP requirements. Processor 104 might also translate these scores into more interpretable forms, such as classification labels or rankings that categorize submissions into groups based on their likelihood of meeting the requirements (e.g., high, medium, low alignment). To refine its accuracy, the machine-learning model may continually update itself by incorporating feedback from the outcomes of vendor selections and the performance of selected vendors in actual projects. This dynamic learning helps the model adjust and improve its scoring metrics based on real-world results and evolving standards in implicit data objects.

With continued reference to FIG. 1, processor 104 is configured to match at least one profile 108 of the plurality of profiles to the at least one RFP as a function of the vendor score 144. Using the vendor score 144, processor 104 can objectively assess the alignment between a vendor's capabilities, experience, and the specific demands of the RFP. The process involves comparing the vendor score against a benchmark or threshold established for the RFP, ensuring that only the vendors whose scores meet or exceed this threshold are considered for the project. This method facilitates a streamlined and efficient vendor selection process, where the likelihood of choosing the most qualified and suitable vendor for the project is significantly increased. Through this automated matching process, the processor ensures that each RFP is paired with profiles that not only meet the basic requirements but also have the potential to deliver optimal results, thus enhancing the overall effectiveness of the procurement process.

With continued reference to FIG. 1, processor 104 may utilize a number of methods to determine the most suitable profile 108 based on predefined criteria. In an embodiment, the processor 104 may compare these vendor scores 144 to a predetermined threshold that represents the minimum acceptable standard for selection. This threshold is set based on the criticality and specific needs of the RFP, ensuring that only vendors whose submissions achieve or exceed this benchmark are considered eligible for the project. Threshold-based filtering may ensure that the selection process maintains a high standard, eliminating vendors who do not meet the essential criteria. This may be useful in scenarios where maintaining quality or meeting strict compliance or technical standards is more important than comparing vendors against one another. Alternatively, the processor 104 may select the vendor based on the highest vendor score among all submissions. This method may be used when the goal is to identify the top performer in a competitive field. After scoring each vendor based on how well their profiles align with the RFP requirements, the processor ranks them according to their scores. The vendor with the highest score may then be selected as the best fit for the RFP. This approach may be beneficial when the differences in vendor capabilities are significant and discernible through their scores, making it clear who the leading candidate is. It maximizes the likelihood of project success by choosing the vendor who is best prepared to meet the project's demands in terms of expertise, experience, and resource availability. In an embodiment, these methods may be combined or modified depending on the complexity of the RFP and the nature of the project. For instance, a threshold might first be used to filter out unsuitable candidates, and then the highest score method could be applied to select the best among the remaining qualified vendors. This hybrid approach helps balance quality assurance with competitive selection, ensuring optimal outcomes for the project.

Still referring to FIG. 1, processor 104 may be configured to display the selected profile 108 using a display device 148. As used in the current disclosure, a “display device” is a device that is used to display a plurality of data or other content. A display device 148 may be configured to display any data described herein. Display device 148 may include a user interface. A “user interface,” as used herein, is a means by which a user and a computer system interact; for example through the use of input devices and software. A user interface may include a graphical user interface (GUI), command line interface (CLI), menu-driven user interface, touch user interface, voice user interface (VUI), form-based user interface, any combination thereof, and the like. A user interface may include a smartphone, smart tablet, desktop, or laptop operated by the user. In an embodiment, the user interface may include a graphical user interface. A “graphical user interface (GUI),” as used herein, is a graphical form of user interface that allows users to interact with electronic devices. A display device may be remote from processor 104. In an embodiment, processor 104 may be configured to transmit any data disclosed herein to a display device or a remote display device. In some embodiments, GUI may include icons, menus, other visual indicators, or representations (graphics), audio indicators such as primary notation, and display information and related user controls. A menu may contain a list of choices and may allow users to select one from them. A menu bar may be displayed horizontally across the screen such as pull-down menu. When any option is clicked in this menu, then the pull-down menu may appear. A menu may include a context menu that appears only when the user performs a specific action. An example of this is pressing the right mouse button. When this is done, a menu may appear under the cursor. Files, programs, web pages and the like may be represented using a small picture in a graphical user interface. Using an icon may be a fast way to open documents, run programs etc. because clicking on them yields instant access. Information contained in user interface may be directly influenced using graphical control elements such as widgets. A “widget,” as used herein, is a user control element that allows a user to control and change the appearance of elements in the user interface. In this context a widget may refer to a generic GUI element such as a check box, button, or scroll bar to an instance of that element, or to a customized collection of such elements used for a specific function or application (such as a dialog box for users to customize their computer screen appearances). User interface controls may include software components that a user interacts with through direct manipulation to read or edit information displayed through user interface. Widgets may be used to display lists of related items, navigate the system using links, tabs, and manipulate data using check boxes, radio boxes, and the like.

Referring now to FIG. 2, an exemplary embodiment of a machine-learning module 200 that may perform one or more machine-learning processes as described in this disclosure is illustrated. Machine-learning module may perform determinations, classification, and/or analysis steps, methods, processes, or the like as described in this disclosure using machine learning processes. A “machine learning process,” as used in this disclosure, is a process that automatedly uses training data 204 to generate an algorithm instantiated in hardware or software logic, data structures, and/or functions that will be performed by a computing device/module to produce outputs 208 given data provided as inputs 212; this is in contrast to a non-machine learning software program where the commands to be executed are determined in advance by a user and written in a programming language.

Still referring to FIG. 2, “training data,” as used herein, is data containing correlations that a machine-learning process may use to model relationships between two or more categories of data elements. For instance, and without limitation, training data 204 may include a plurality of data entries, also known as “training examples,” each entry representing a set of data elements that were recorded, received, and/or generated together; data elements may be correlated by shared existence in a given data entry, by proximity in a given data entry, or the like. Multiple data entries in training data 204 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 204 according to various correlations; correlations may indicate causative and/or predictive links between categories of data elements, which may be modeled as relationships such as mathematical relationships by machine-learning processes as described in further detail below. Training data 204 may be formatted and/or organized by categories of data elements, for instance by associating data elements with one or more descriptors corresponding to categories of data elements. As a non-limiting example, training data 204 may include data entered in standardized forms by persons or processes, such that entry of a given data element in a given field in a form may be mapped to one or more descriptors of categories. Elements in training data 204 may be linked to descriptors of categories by tags, tokens, or other data elements; for instance, and without limitation, training data 204 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively or additionally, and continuing to refer to FIG. 2, training data 204 may include one or more elements that are not categorized; that is, training data 204 may not be formatted or contain descriptors for some elements of data. Machine-learning algorithms and/or other processes may sort training data 204 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 204 to be made applicable for two or more distinct machine-learning algorithms as described in further detail below. Training data 204 used by machine-learning module 200 may correlate any input data as described in this disclosure to any output data as described in this disclosure. As a non-limiting illustrative examples of pairs of submissions and implicit data objects as inputs correlated to examples of vendor score as outputs.

Further referring to FIG. 2, training data may be filtered, sorted, and/or selected using one or more supervised and/or unsupervised machine-learning processes and/or models as described in further detail below; such models may include without limitation a training data classifier 216. Training data classifier 216 may include a “classifier,” which as used in this disclosure is a machine-learning model as defined below, such as a data structure representing and/or using a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. A distance metric may include any norm, such as, without limitation, a Pythagorean norm. Machine-learning module 200 may generate a classifier using a classification algorithm, defined as a processes whereby a computing device and/or any module and/or component operating thereon derives a classifier from training data 204. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers. As a non-limiting example, training data classifier 216 may classify elements of training data to submissions 140 from vendors with similar proposal codes 132. In an embodiment, historical submissions 140 tagged with proposal codes 132 may be used as labeled training data.

With further reference to FIG. 2, training examples for use as training data may be selected from a population of potential examples according to cohorts relevant to an analytical problem to be solved, a classification task, or the like. Alternatively or additionally, training data may be selected to span a set of likely circumstances or inputs for a machine-learning model and/or process to encounter when deployed. For instance, and without limitation, for each category of input data to a machine-learning process or model that may exist in a range of values in a population of phenomena such as images, user data, process data, physical data, or the like, a computing device, processor, and/or machine-learning model may select training examples representing each possible value on such a range and/or a representative sample of values on such a range. Selection of a representative sample may include selection of training examples in proportions matching a statistically determined and/or predicted distribution of such values according to relative frequency, such that, for instance, values encountered more frequently in a population of data so analyzed are represented by more training examples than values that are encountered less frequently. Alternatively or additionally, a set of training examples may be compared to a collection of representative values in a database and/or presented to a user, so that a process can detect, automatically or via user input, one or more values that are not included in the set of training examples. Computing device, processor, and/or module may automatically generate a missing training example; this may be done by receiving and/or retrieving a missing input and/or output value and correlating the missing input and/or output value with a corresponding output and/or input value collocated in a data record with the retrieved value, provided by a user and/or other device, or the like.

Still referring to FIG. 2, computer, processor, and/or module may be configured to sanitize training data. “Sanitizing” training data, as used in this disclosure, is a process whereby training examples are removed that interfere with convergence of a machine-learning model and/or process to a useful result. For instance, and without limitation, a training example may include an input and/or output value that is an outlier from typically encountered values, such that a machine-learning algorithm using the training example will be adapted to an unlikely amount as an input and/or output; a value that is more than a threshold number of standard deviations away from an average, mean, or expected value, for instance, may be eliminated. Alternatively or additionally, one or more training examples may be identified as having poor quality data, where “poor quality” is defined as having a signal to noise ratio below a threshold value.

As a non-limiting example, and with further reference to FIG. 2, images used to train an image classifier or other machine-learning model and/or process that takes images as inputs or generates images as outputs may be rejected if image quality is below a threshold value. For instance, and without limitation, computing device, processor, and/or module may perform blur detection, and eliminate one or more Blur detection may be performed, as a non-limiting example, by taking Fourier transform, or an approximation such as a Fast Fourier Transform (FFT) of the image and analyzing a distribution of low and high frequencies in the resulting frequency-domain depiction of the image; numbers of high-frequency values below a threshold level may indicate blurriness. As a further non-limiting example, detection of blurriness may be performed by convolving an image, a channel of an image, or the like with a Laplacian kernel; this may generate a numerical score reflecting a number of rapid changes in intensity shown in the image, such that a high score indicates clarity, and a low score indicates blurriness. Blurriness detection may be performed using a gradient-based operator, which measures operators based on the gradient or first derivative of an image, based on the hypothesis that rapid changes indicate sharp edges in the image, and thus are indicative of a lower degree of blurriness. Blur detection may be performed using Wavelet-based operator, which takes advantage of the capability of coefficients of the discrete wavelet transform to describe the frequency and spatial content of images. Blur detection may be performed using statistics-based operators take advantage of several image statistics as texture descriptors in order to compute a focus level. Blur detection may be performed by using discrete cosine transform (DCT) coefficients in order to compute a focus level of an image from its frequency content.

Continuing to refer to FIG. 2, computing device, processor, and/or module may be configured to precondition one or more training examples. For instance, and without limitation, where a machine learning model and/or process has one or more inputs and/or outputs requiring, transmitting, or receiving a certain number of bits, samples, or other units of data, one or more training examples' elements to be used as or compared to inputs and/or outputs may be modified to have such a number of units of data. For instance, a computing device, processor, and/or module may convert a smaller number of units, such as in a low pixel count image, into a desired number of units, for instance by upsampling and interpolating. As a non-limiting example, a low pixel count image may have 100 pixels, however a desired number of pixels may be 128. Processor may interpolate the low pixel count image to convert the 100 pixels into 128 pixels. It should also be noted that one of ordinary skill in the art, upon reading this disclosure, would know the various methods to interpolate a smaller number of data units such as samples, pixels, bits, or the like to a desired number of such units. In some instances, a set of interpolation rules may be trained by sets of highly detailed inputs and/or outputs and corresponding inputs and/or outputs downsampled to smaller numbers of units, and a neural network or other machine learning model that is trained to predict interpolated pixel values using the training data. As a non-limiting example, a sample input and/or output, such as a sample picture, with sample-expanded data units (e.g., pixels added between the original pixels) may be input to a neural network or machine-learning model and output a pseudo replica sample-picture with dummy values assigned to pixels between the original pixels based on a set of interpolation rules. As a non-limiting example, in the context of an image classifier, a machine-learning model may have a set of interpolation rules trained by sets of highly detailed images and images that have been downsampled to smaller numbers of pixels, and a neural network or other machine learning model that is trained using those examples to predict interpolated pixel values in a facial picture context. As a result, an input with sample-expanded data units (the ones added between the original data units, with dummy values) may be run through a trained neural network and/or model, which may fill in values to replace the dummy values. Alternatively or additionally, processor, computing device, and/or module may utilize sample expander methods, a low-pass filter, or both. As used in this disclosure, a “low-pass filter” is a filter that passes signals with a frequency lower than a selected cutoff frequency and attenuates signals with frequencies higher than the cutoff frequency. The exact frequency response of the filter depends on the filter design. Computing device, processor, and/or module may use averaging, such as luma or chroma averaging in images, to fill in data units in between original data units.

In some embodiments, and with continued reference to FIG. 2, computing device, processor, and/or module may down-sample elements of a training example to a desired lower number of data elements. As a non-limiting example, a high pixel count image may have 256 pixels, however a desired number of pixels may be 128. Processor may down-sample the high pixel count image to convert the 256 pixels into 128 pixels. In some embodiments, processor may be configured to perform downsampling on data. Downsampling, also known as decimation, may include removing every Nth entry in a sequence of samples, all but every Nth entry, or the like, which is a process known as “compression,” and may be performed, for instance by an N-sample compressor implemented using hardware or software. Anti-aliasing and/or anti-imaging filters, and/or low-pass filters, may be used to clean up side-effects of compression.

Still referring to FIG. 2, machine-learning module 200 may be configured to perform a lazy-learning process 220 and/or protocol, which may alternatively be referred to as a “lazy loading” or “call-when-needed” process and/or protocol, may be a process whereby machine learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 204. Heuristic may include selecting some number of highest-ranking associations and/or training data 204 elements. Lazy learning may implement any suitable lazy learning algorithm, including without limitation a K-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively or additionally, and with continued reference to FIG. 2, machine-learning processes as described in this disclosure may be used to generate machine-learning models 224. A “machine-learning model,” as used in this disclosure, is a data structure representing and/or instantiating a mathematical and/or algorithmic representation of a relationship between inputs and outputs, as generated using any machine-learning process including without limitation any process as described above, and stored in memory; an input is submitted to a machine-learning model 224 once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 224 may be generated by creating an artificial neural network, such as a convolutional neural network comprising an input layer of nodes, one or more intermediate layers, and an output layer of nodes. Connections between nodes may be created via the process of “training” the network, in which elements from a training data 204 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 2, machine-learning algorithms may include at least a supervised machine-learning process 228. At least a supervised machine-learning process 228, as defined herein, include algorithms that receive a training set relating a number of inputs to a number of outputs, and seek to generate one or more data structures representing and/or instantiating one or more mathematical relations relating inputs to outputs, where each of the one or more mathematical relations is optimal according to some criterion specified to the algorithm using some scoring function. For instance, a supervised learning algorithm may include examples of pairs of submissions and implicit data objects as described above as inputs, examples of vendor score as outputs, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 204. Persons skilled in the art, upon reviewing the entirety of this disclosure, will be aware of various possible variations of at least a supervised machine-learning process 228 that may be used to determine relation between inputs and outputs. Supervised machine-learning processes may include classification algorithms as defined above.

With further reference to FIG. 2, training a supervised machine-learning process may include, without limitation, iteratively updating coefficients, biases, weights based on an error function, expected loss, and/or risk function. For instance, an output generated by a supervised machine-learning model using an input example in a training example may be compared to an output example from the training example; an error function may be generated based on the comparison, which may include any error function suitable for use with any machine-learning algorithm described in this disclosure, including a square of a difference between one or more sets of compared values or the like. Such an error function may be used in turn to update one or more weights, biases, coefficients, or other parameters of a machine-learning model through any suitable process including without limitation gradient descent processes, least-squares processes, and/or other processes described in this disclosure. This may be done iteratively and/or recursively to gradually tune such weights, biases, coefficients, or other parameters. Updating may be performed, in neural networks, using one or more back-propagation algorithms. Iterative and/or recursive updates to weights, biases, coefficients, or other parameters as described above may be performed until currently available training data is exhausted and/or until a convergence test is passed, where a “convergence test” is a test for a condition selected as indicating that a model and/or weights, biases, coefficients, or other parameters thereof has reached a degree of accuracy. A convergence test may, for instance, compare a difference between two or more successive errors or error function values, where differences below a threshold amount may be taken to indicate convergence. Alternatively or additionally, one or more errors and/or error function values evaluated in training iterations may be compared to a threshold.

Still referring to FIG. 2, a computing device, processor, and/or module may be configured to perform method, method step, sequence of method steps and/or algorithm described in reference to this figure, in any order and with any degree of repetition. For instance, a computing device, processor, and/or module may be configured to perform a single step, sequence and/or algorithm repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. A computing device, processor, and/or module may perform any step, sequence of steps, or algorithm in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Further referring to FIG. 2, machine learning processes may include at least an unsupervised machine-learning processes 232. An unsupervised machine-learning process, as used herein, is a process that derives inferences in datasets without regard to labels; as a result, an unsupervised machine-learning process may be free to discover any structure, relationship, and/or correlation provided in the data. Unsupervised processes 232 may not require a response variable; unsupervised processes 232 may be used to find interesting patterns and/or inferences between variables, to determine a degree of correlation between two or more variables, or the like.

Still referring to FIG. 2, machine-learning module 200 may be designed and configured to create a machine-learning model 224 using techniques for development of linear regression models. Linear regression models may include ordinary least squares regression, which aims to minimize the square of the difference between predicted outcomes and actual outcomes according to an appropriate norm for measuring such a difference (e.g., a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g. a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 2, machine-learning algorithms may include, without limitation, linear discriminant analysis. Machine-learning algorithm may include quadratic discriminant analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include various forms of latent space regularization such as variational regularization. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized trees, AdaBoost, gradient tree boosting, and/or voting classifier methods. Machine-learning algorithms may include neural net algorithms, including convolutional neural net processes.

Still referring to FIG. 2, a machine-learning model and/or process may be deployed or instantiated by incorporation into a program, apparatus, system and/or module. For instance, and without limitation, a machine-learning model, neural network, and/or some or all parameters thereof may be stored and/or deployed in any memory or circuitry. Parameters such as coefficients, weights, and/or biases may be stored as circuit-based constants, such as arrays of wires and/or binary inputs and/or outputs set at logic “1” and “0” voltage levels in a logic circuit to represent a number according to any suitable encoding system including twos complement or the like or may be stored in any volatile and/or non-volatile memory. Similarly, mathematical operations and input and/or output of data to or from models, neural network layers, or the like may be instantiated in hardware circuitry and/or in the form of instructions in firmware, machine-code such as binary operation code instructions, assembly language, or any higher-order programming language. Any technology for hardware and/or software instantiation of memory, instructions, data structures, and/or algorithms may be used to instantiate a machine-learning process and/or model, including without limitation any combination of production and/or configuration of non-reconfigurable hardware elements, circuits, and/or modules such as without limitation ASICs, production and/or configuration of reconfigurable hardware elements, circuits, and/or modules such as without limitation FPGAs, production and/or of non-reconfigurable and/or configuration non-rewritable memory elements, circuits, and/or modules such as without limitation non-rewritable ROM, production and/or configuration of reconfigurable and/or rewritable memory elements, circuits, and/or modules such as without limitation rewritable ROM or other memory technology described in this disclosure, and/or production and/or configuration of any computing device and/or component thereof as described in this disclosure. Such deployed and/or instantiated machine-learning model and/or algorithm may receive inputs from any other process, module, and/or component described in this disclosure, and produce outputs to any other process, module, and/or component described in this disclosure.

Continuing to refer to FIG. 2, any process of training, retraining, deployment, and/or instantiation of any machine-learning model and/or algorithm may be performed and/or repeated after an initial deployment and/or instantiation to correct, refine, and/or improve the machine-learning model and/or algorithm. Such retraining, deployment, and/or instantiation may be performed as a periodic or regular process, such as retraining, deployment, and/or instantiation at regular elapsed time periods, after some measure of volume such as a number of bytes or other measures of data processed, a number of uses or performances of processes described in this disclosure, or the like, and/or according to a software, firmware, or other update schedule. Alternatively or additionally, retraining, deployment, and/or instantiation may be event-based, and may be triggered, without limitation, by user inputs indicating sub-optimal or otherwise problematic performance and/or by automated field testing and/or auditing processes, which may compare outputs of machine-learning models and/or algorithms, and/or errors and/or error functions thereof, to any thresholds, convergence tests, or the like, and/or may compare outputs of processes described herein to similar thresholds, convergence tests or the like. Event-based retraining, deployment, and/or instantiation may alternatively or additionally be triggered by receipt and/or generation of one or more new training examples; a number of new training examples may be compared to a preconfigured threshold, where exceeding the preconfigured threshold may trigger retraining, deployment, and/or instantiation.

Still referring to FIG. 2, retraining and/or additional training may be performed using any process for training described above, using any currently or previously deployed version of a machine-learning model and/or algorithm as a starting point. Training data for retraining may be collected, preconditioned, sorted, classified, sanitized, or otherwise processed according to any process described in this disclosure. Training data may include, without limitation, training examples including inputs and correlated outputs used, received, and/or generated from any version of any system, module, machine-learning model or algorithm, apparatus, and/or method described in this disclosure; such examples may be modified and/or labeled according to user feedback or other processes to indicate desired results, and/or may have actual or measured results from a process being modeled and/or predicted by system, module, machine-learning model or algorithm, apparatus, and/or method as “desired” results to be compared to outputs for training processes as described above.

Redeployment may be performed using any reconfiguring and/or rewriting of reconfigurable and/or rewritable circuit and/or memory elements; alternatively, redeployment may be performed by production of new hardware and/or software components, circuits, instructions, or the like, which may be added to and/or may replace existing hardware and/or software components, circuits, instructions, or the like.

Further referring to FIG. 2, one or more processes or algorithms described above may be performed by at least a dedicated hardware unit 236. A “dedicated hardware unit,” for the purposes of this figure, is a hardware component, circuit, or the like, aside from a principal control circuit and/or processor performing method steps as described in this disclosure, that is specifically designated or selected to perform one or more specific tasks and/or processes described in reference to this figure, such as without limitation preconditioning and/or sanitization of training data and/or training a machine-learning algorithm and/or model. A dedicated hardware unit 236 may include, without limitation, a hardware unit that can perform iterative or massed calculations, such as matrix-based calculations to update or tune parameters, weights, coefficients, and/or biases of machine-learning models and/or neural networks, efficiently using pipelining, parallel processing, or the like; such a hardware unit may be optimized for such processes by, for instance, including dedicated circuitry for matrix and/or signal processing operations that includes, e.g., multiple arithmetic and/or logical circuit units such as multipliers and/or adders that can act simultaneously and/or in parallel or the like. Such dedicated hardware units 236 may include, without limitation, graphical processing units (GPUs), dedicated signal processing modules, FPGA or other reconfigurable hardware that has been configured to instantiate parallel processing units for one or more specific tasks, or the like, A computing device, processor, apparatus, or module may be configured to instruct one or more dedicated hardware units 236 to perform one or more operations described herein, such as evaluation of model and/or algorithm outputs, one-time or iterative updates to parameters, coefficients, weights, and/or biases, and/or any other operations such as vector and/or matrix operations as described in this disclosure.

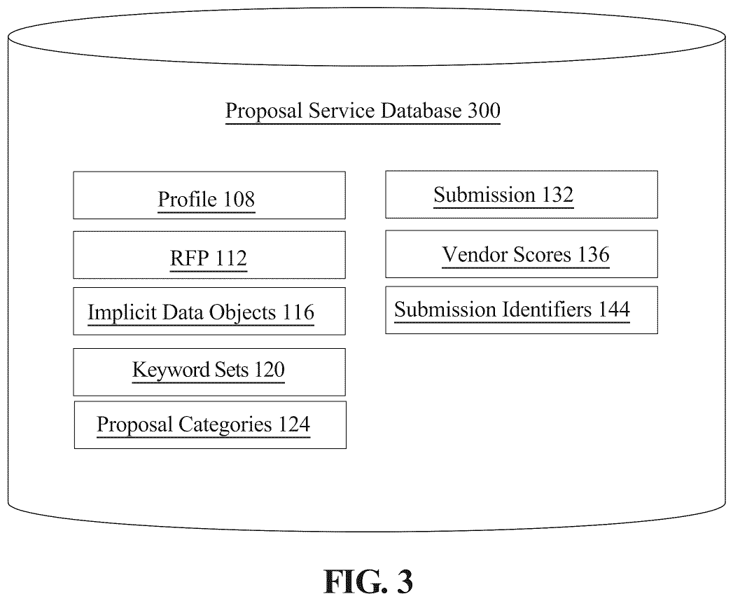

Now referring to FIG. 3, an exemplary proposal database 300 is illustrated by way of block diagram. In an embodiment, any past or present versions of any data disclosed herein may be stored within the proposal database 300 including but not limited to: RFP 112, profile 108, keyword sets 120, proposal categories 124, implicit data objects 116, submissions 140, proposal codes 132, vendor scores 144, selected vendors, and the like. Processor 104 may be communicatively connected with proposal database 300. For example, in some cases, database 300 may be local to processor 104. Alternatively or additionally, in some cases, database 300 may be remote to processor 104 and communicative with processor 104 by way of one or more networks. Network may include, but not limited to, a cloud network, a mesh network, or the like. By way of example, a “cloud-based” system, as that term is used herein, can refer to a system which includes software and/or data which is stored, managed, and/or processed on a network of remote servers hosted in the “cloud,” e.g., via the Internet, rather than on local severs or personal computers. A “mesh network” as used in this disclosure is a local network topology in which the infrastructure processor 104 connects directly, dynamically, and non-hierarchically to as many other computing devices as possible. A “network topology” as used in this disclosure is an arrangement of elements of a communication network. proposal database 300 may be implemented, without limitation, as a relational database, a key-value retrieval database such as a NOSQL database, or any other format or structure for use as a database that a person skilled in the art would recognize as suitable upon review of the entirety of this disclosure. proposal database 300 may alternatively or additionally be implemented using a distributed data storage protocol and/or data structure, such as a distributed hash table or the like. proposal database 300 may include a plurality of data entries and/or records as described above. Data entries in a database may be flagged with or linked to one or more additional elements of information, which may be reflected in data entry cells and/or in linked tables such as tables related by one or more indices in a relational database. Persons skilled in the art, upon reviewing the entirety of this disclosure, will be aware of various ways in which data entries in a database may store, retrieve, organize, and/or reflect data and/or records as used herein, as well as categories and/or populations of data consistently with this disclosure.

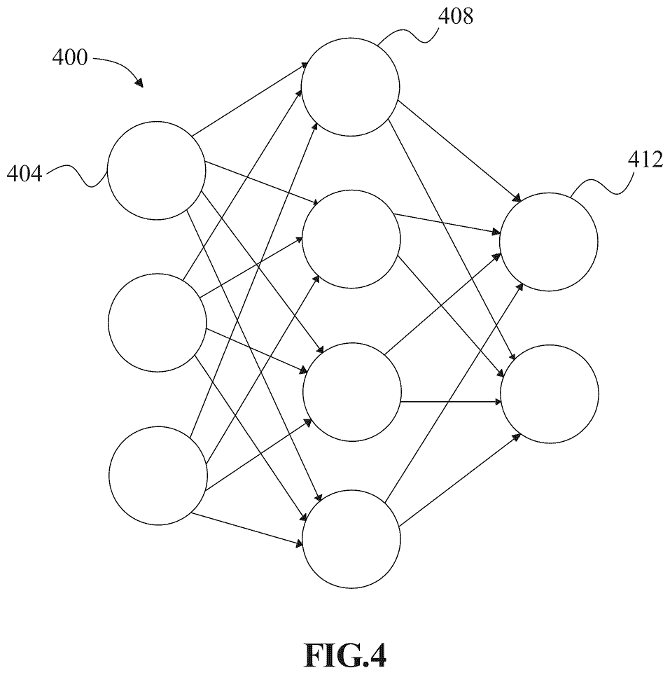

Referring now to FIG. 4, an exemplary embodiment of neural network 400 is illustrated. A neural network 400, also known as an artificial neural network, is a network of “nodes,” or data structures having one or more inputs, one or more outputs, and a function determining outputs based on inputs. Such nodes may be organized in a network, such as without limitation a convolutional neural network, including an input layer of nodes 404, one or more intermediate layers 408, and an output layer of nodes 412. Connections between nodes may be created via the process of “training” the network, in which elements from a training dataset are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning. Connections may run solely from input nodes toward output nodes in a “feed-forward” network or may feed outputs of one layer back to inputs of the same or a different layer in a “recurrent network.” As a further non-limiting example, a neural network may include a convolutional neural network comprising an input layer of nodes, one or more intermediate layers, and an output layer of nodes. A “convolutional neural network,” as used in this disclosure, is a neural network in which at least one hidden layer is a convolutional layer that convolves inputs to that layer with a subset of inputs known as a “kernel,” along with one or more additional layers such as pooling layers, fully connected layers, and the like.

Referring now to FIG. 5, an exemplary embodiment of a node of a neural network is illustrated. A node may include, without limitation, a plurality of inputs xᵢ that may receive numerical values from inputs to a neural network containing the node and/or from other nodes. Node may perform a weighted sum of inputs using weights wᵢ that are multiplied by respective inputs xᵢ. Additionally or alternatively, a bias b may be added to the weighted sum of the inputs such that an offset is added to each unit in the neural network layer that is independent of the input to the layer. The weighted sum may then be input into a function φ, which may generate one or more outputs y. Weight wᵢ applied to an input xᵢ may indicate whether the input is “excitatory,” indicating that it has strong influence on the one or more outputs y, for instance by the corresponding weight having a large numerical value, and/or a “inhibitory,” indicating it has a weak effect influence on the one more inputs y, for instance by the corresponding weight having a small numerical value. The values of weights wᵢ may be determined by training a neural network using training data, which may be performed using any suitable process as described above.

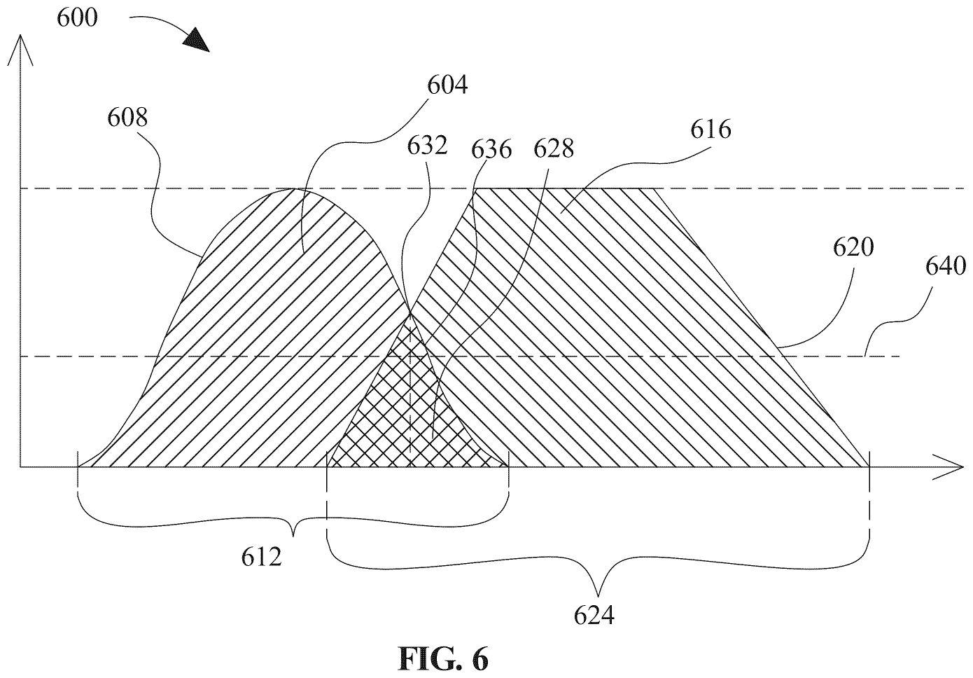

Now referring to FIG. 6, an exemplary embodiment of fuzzy set comparison 600 is illustrated. In a non-limiting embodiment, the fuzzy set comparison. In a non-limiting embodiment, fuzzy set comparison 600 may be consistent with fuzzy set comparison in FIG. 1. In another non-limiting the fuzzy set comparison 600 may be consistent with the name/version matching as described herein. For example and without limitation, the parameters, weights, and/or coefficients of the membership functions may be tuned using any machine-learning methods for the name/version matching as described herein. In another non-limiting embodiment, the fuzzy set may represent an implicit data objects 116 and a submissions 140 from FIG. 1.

Alternatively or additionally, and still referring to FIG. 6, fuzzy set comparison 600 may be generated as a function of determining the data compatibility threshold. The compatibility threshold may be determined by a computing device. In some embodiments, a computing device may use a logic comparison program, such as, but not limited to, a fuzzy logic model to determine the compatibility threshold and/or version authenticator. Each such compatibility threshold may be represented as a value for a posting variable representing the compatibility threshold, or in other words a fuzzy set as described above that corresponds to a degree of compatibility and/or allowability as calculated using any statistical, machine-learning, or other method that may occur to a person skilled in the art upon reviewing the entirety of this disclosure. In some embodiments, determining the compatibility threshold and/or version authenticator may include using a linear regression model. A linear regression model may include a machine learning model. A linear regression model may map statistics such as, but not limited to, frequency of the same range of version numbers, and the like, to the compatibility threshold and/or version authenticator. In some embodiments, determining the compatibility threshold of any posting may include using a classification model. A classification model may be configured to input collected data and cluster data to a centroid based on, but not limited to, frequency of appearance of the range of versioning numbers, linguistic indicators of compatibility and/or allowability, and the like. Centroids may include scores assigned to them such that the compatibility threshold may each be assigned a score. In some embodiments, a classification model may include a K-means clustering model. In some embodiments, a classification model may include a particle swarm optimization model. In some embodiments, determining a compatibility threshold may include using a fuzzy inference engine. A fuzzy inference engine may be configured to map one or more compatibility threshold using fuzzy logic. In some embodiments, a plurality of computing devices may be arranged by a logic comparison program into compatibility arrangements. A “compatibility arrangement” as used in this disclosure is any grouping of objects and/or data based on skill level and/or output score. Membership function coefficients and/or constants as described above may be tuned according to classification and/or clustering algorithms. For instance, and without limitation, a clustering algorithm may determine a Gaussian or other distribution of questions about a centroid corresponding to a given compatibility threshold and/or version authenticator, and an iterative or other method may be used to find a membership function, for any membership function type as described above, that minimizes an average error from the statistically determined distribution, such that, for instance, a triangular or Gaussian membership function about a centroid representing a center of the distribution that most closely matches the distribution. Error functions to be minimized, and/or methods of minimization, may be performed without limitation according to any error function and/or error function minimization process and/or method as described in this disclosure.

Still referring to FIG. 6, inference engine may be implemented according to input implicit data objects 116 and submissions 140. For instance, an acceptance variable may represent a first measurable value pertaining to the classification of implicit data objects 116 to submissions 140. Continuing the example, an output variable may represent vendor score 144 associated with the user. In an embodiment, implicit data objects 116 and/or submissions 140 may be represented by their own fuzzy set. In other embodiments, the classification of the data into vendor score 144 may be represented as a function of the intersection two fuzzy sets as shown in FIG. 6, An inference engine may combine rules, such as any semantic versioning, semantic language, version ranges, and the like thereof. The degree to which a given input function membership matches a given rule may be determined by a triangular norm or “T-norm” of the rule or output function with the input function, such as min (a, b), product of a and b, drastic product of a and b, Hamacher product of a and b, or the like, satisfying the rules of commutativity (T(a, b)=T(b, a)), monotonicity: (T(a, b)≤T(c, d) if a≤c and b≤d), (associativity: T(a, T(b, c))=T (T(a, b), c)), and the requirement that the number 1 acts as an identity element. Combinations of rules (“and” or “or” combination of rule membership determinations) may be performed using any T-conorm, as represented by an inverted T symbol or “⊥,” such as max(a, b), probabilistic sum of a and b (a+b−a*b), bounded sum, and/or drastic T-conorm; any T-conorm may be used that satisfies the properties of commutativity: ⊥(a, b)=⊥(b, a), monotonicity: ⊥(a, b)≤⊥(c, d) if a≤c and b≤d, associativity: ⊥(a, ⊥(b, c))=⊥(⊥(a, b), c), and identity element of 0. Alternatively or additionally T-conorm may be approximated by sum, as in a “product-sum” inference engine in which T-norm is product and T-conorm is sum. A final output score or other fuzzy inference output may be determined from an output membership function as described above using any suitable defuzzification process, including without limitation Mean of Max defuzzification, Centroid of Area/Center of Gravity defuzzification, Center Average defuzzification, Bisector of Area defuzzification, or the like. Alternatively or additionally, output rules may be replaced with functions according to the Takagi-Sugeno-King (TSK) fuzzy model.

A first fuzzy set 604 may be represented, without limitation, according to a first membership function 608 representing a probability that an input falling on a first range of values 612 is a member of the first fuzzy set 604, where the first membership function 608 has values on a range of probabilities such as without limitation the interval [0,1], and an area beneath the first membership function 608 may represent a set of values within first fuzzy set 604. Although first range of values 612 is illustrated for clarity in this exemplary depiction as a range on a single number line or axis, first range of values 612 may be defined on two or more dimensions, representing, for instance, a Cartesian product between a plurality of ranges, curves, axes, spaces, dimensions, or the like. First membership function 608 may include any suitable function mapping first range 612 to a probability interval, including without limitation a triangular function defined by two linear elements such as line segments or planes that intersect at or below the top of the probability interval. As a non-limiting example, triangular membership function may be defined as:

$$( x , a , b , c ) = \{ \begin{matrix}0 , for x > c and x < a \\ \frac{x - a}{b - a} , for a \leq x < b \\ \frac{c - x}{c - b} , if b < x \leq c\end{matrix}$$

a trapezoidal membership function may be defined as:

$$y ( x , a , b , c , d ) = max ( min ( \frac{x - a}{b - a} , 1 , \frac{d - x}{d - c} ) , 0 )$$

a sigmoidal function may be defined as:

$$y ( x , a , c ) = \frac{1}{1 - {e}^{- a ( x - c )}}$$

a Gaussian membership function may be defined as:

$$y ( x , c , σ ) = {e}^{- \frac{1}{2} {( \frac{x - c}{σ} )}^{2}}$$

and a bell membership function may be defined as:

$$y ( x , a , b , c , ) = {[ 1 + {\vert \frac{x - c}{a} \vert}^{2 b} ]}^{- 1}$$

Persons skilled in the art, upon reviewing the entirety of this disclosure, will be aware of various alternative or additional membership functions that may be used consistently with this disclosure.

First fuzzy set 604 may represent any value or combination of values as described above, including any implicit data objects 116 and submissions 140. A second fuzzy set 616, which may represent any value which may be represented by first fuzzy set 604, may be defined by a second membership function 620 on a second range 624; second range 624 may be identical and/or overlap with first range 612 and/or may be combined with first range via Cartesian product or the like to generate a mapping permitting evaluation overlap of first fuzzy set 604 and second fuzzy set 616. Where first fuzzy set 604 and second fuzzy set 616 have a region 636 that overlaps, first membership function 608 and second membership function 620 may intersect at a point 632 representing a probability, as defined on probability interval, of a match between first fuzzy set 604 and second fuzzy set 616. Alternatively or additionally, a single value of first and/or second fuzzy set may be located at a locus 636 on first range 612 and/or second range 624, where a probability of membership may be taken by evaluation of first membership function 608 and/or second membership function 620 at that range point. A probability at 628 and/or 632 may be compared to a threshold 640 to determine whether a positive match is indicated. Threshold 640 may, in a non-limiting example, represent a degree of match between first fuzzy set 604 and second fuzzy set 616, and/or single values therein with each other or with either set, which is sufficient for purposes of the matching process; for instance, the classification into one or more query categories may indicate a sufficient degree of overlap with fuzzy set representing implicit data objects 116 and submissions 140 for combination to occur as described above. Each threshold may be established by one or more user inputs. Alternatively or additionally, each threshold may be tuned by a machine-learning and/or statistical process, for instance and without limitation as described in further detail below.

In an embodiment, a degree of match between fuzzy sets may be used to rank one resource against another. For instance, if both implicit data objects 116 and submissions 140 have fuzzy sets, vendor score 144 may be generated by having a degree of overlap exceeding a predictive threshold, processor 104 may further rank the two resources by ranking a resource having a higher degree of match more highly than a resource having a lower degree of match. Where multiple fuzzy matches are performed, degrees of match for each respective fuzzy set may be computed and aggregated through, for instance, addition, averaging, or the like, to determine an overall degree of match, which may be used to rank resources; selection between two or more matching resources may be performed by selection of a highest-ranking resource, and/or multiple notifications may be presented to a user in order of ranking.

Referring to FIG. 7, a chatbot system 700 is schematically illustrated. According to some embodiments, a user interface 704 may be communicative with a computing device 708 that is configured to operate a chatbot. In some cases, user interface 704 may be local to computing device 708. Alternatively or additionally, in some cases, user interface 704 may remote to computing device 708 and communicative with the computing device 708, by way of one or more networks, such as without limitation the internet. Alternatively or additionally, user interface 704 may communicate with user device 708 using telephonic devices and networks, such as without limitation fax machines, short message service (SMS), or multimedia message service (MMS). Commonly, user interface 704 communicates with computing device 708 using text-based communication, for example without limitation using a character encoding protocol, such as American Standard for Information Interchange (ASCII). Typically, a user interface 704 conversationally interfaces a chatbot, by way of at least a submission 712, from the user interface 708 to the chatbot, and a response 716, from the chatbot to the user interface 704. In many cases, one or both submission 712 and response 716 are text-based communication. Alternatively or additionally, in some cases, one or both of submission 712 and response 716 are audio-based communication.

Continuing in reference to FIG. 7, a submission 712 once received by computing device 708 operating a chatbot, may be processed by a processor. In some embodiments, processor processes a submission 712 using one or more of keyword recognition, pattern matching, and natural language processing. In some embodiments, processor employs real-time learning with evolutionary algorithms. In some cases, processor may retrieve a pre-prepared response from at least a storage component 720, based upon submission 712. Alternatively or additionally, in some embodiments, processor communicates a response 716 without first receiving a submission 712, thereby initiating conversation. In some cases, processor communicates an inquiry to user interface 704; and the processor is configured to process an answer to the inquiry in a following submission 712 from the user interface 704. In some cases, an answer to an inquiry present within a submission 712 from a user device 704 may be used by computing device 708 as an input to another function.

With continued reference to FIG. 7, A chatbot may be configured to provide a user with a plurality of options as an input into the chatbot. Chatbot entries may include multiple choice, short answer response, true or false responses, and the like. A user may decide on what type of chatbot entries are appropriate. In some embodiments, the chatbot may be configured to allow the user to input a freeform response into the chatbot. The chatbot may then use a decision tree, data base, or other data structure to respond to the users entry into the chatbot as a function of a chatbot input. As used in the current disclosure, “Chatbot input” is any response that a candidate or employer inputs in to a chatbot as a response to a prompt or question.

With continuing reference to FIG. 7, computing device 708 may be configured to the respond to a chatbot input using a decision tree. A “decision tree,” as used in this disclosure, is a data structure that represents and combines one or more determinations or other computations based on and/or concerning data provided thereto, as well as earlier such determinations or calculations, as nodes of a tree data structure where inputs of some nodes are connected to outputs of others. Decision tree may have at least a root node, or node that receives data input to the decision tree, corresponding to at least a candidate input into a chatbot. Decision tree has at least a terminal node, which may alternatively or additionally be referred to herein as a “leaf node,” corresponding to at least an exit indication; in other words, decision and/or determinations produced by decision tree may be output at the at least a terminal node. Decision tree may include one or more internal nodes, defined as nodes connecting outputs of root nodes to inputs of terminal nodes. Computing device 708 may generate two or more decision trees, which may overlap; for instance, a root node of one tree may connect to and/or receive output from one or more terminal nodes of another tree, intermediate nodes of one tree may be shared with another tree, or the like.

Still referring to FIG. 7, computing device 708 may build decision tree by following relational identification; for example, relational indication may specify that a first rule module receives an input from at least a second rule module and generates an output to at least a third rule module, and so forth, which may indicate to computing device 708 an in which such rule modules will be placed in decision tree. Building decision tree may include recursively performing mapping of execution results output by one tree and/or subtree to root nodes of another tree and/or subtree, for instance by using such execution results as execution parameters of a subtree. In this manner, computing device 708 may generate connections and/or combinations of one or more trees to one another to define overlaps and/or combinations into larger trees and/or combinations thereof. Such connections and/or combinations may be displayed by visual interface to user, for instance in first view, to enable viewing, editing, selection, and/or deletion by user; connections and/or combinations generated thereby may be highlighted, for instance using a different color, a label, and/or other form of emphasis aiding in identification by a user. In some embodiments, subtrees, previously constructed trees, and/or entire data structures may be represented and/or converted to rule modules, with graphical models representing them, and which may then be used in further iterations or steps of generation of decision tree and/or data structure. Alternatively or additionally subtrees, previously constructed trees, and/or entire data structures may be converted to APIs to interface with further iterations or steps of methods as described in this disclosure. As a further example, such subtrees, previously constructed trees, and/or entire data structures may become remote resources to which further iterations or steps of data structures and/or decision trees may transmit data and from which further iterations or steps of generation of data structure receive data, for instance as part of a decision in a given decision tree node.

Continuing to refer to FIG. 7, decision tree may incorporate one or more manually entered or otherwise provided decision criteria. Decision tree may incorporate one or more decision criteria using an application programmer interface (API). Decision tree may establish a link to a remote decision module, device, system, or the like. Decision tree may perform one or more database lookups and/or look-up table lookups. Decision tree may include at least a decision calculation module, which may be imported via an API, by incorporation of a program module in source code, executable, or other form, and/or linked to a given node by establishing a communication interface with one or more exterior processes, programs, systems, remote devices, or the like; for instance, where a user operating system has a previously existent calculation and/or decision engine configured to make a decision corresponding to a given node, for instance and without limitation using one or more elements of domain knowledge, by receiving an input and producing an output representing a decision, a node may be configured to provide data to the input and receive the output representing the decision, based upon which the node may perform its decision.

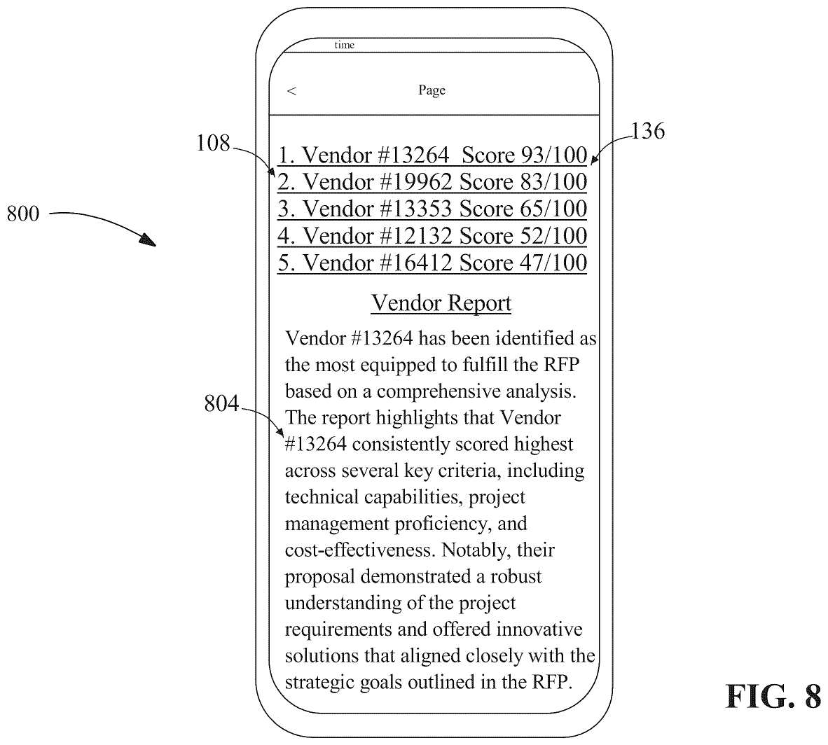

Referring now to FIG. 8, an exemplary embodiment of a user interface 800. User interface 800 may be configured to display a vendor report 804. As used in the current disclosure, a “vendor report” is a report that compiles the evaluation of the vendors according to how will they align with the implicit data objects 116. A vendor report 804 may be a document that synthesizes and presents data on vendors based on their performance metrics, capabilities, and alignment with specific RFP criteria. This report may be produced by analyzing and comparing the vendor scores 144 that reflect how well each vendor meets the implicit data objects 116 set out in an RFP. The rankings are typically derived from a systematic evaluation process where each profile is scored against a set of predefined criteria, and these scores are used to order the vendors from most to least suitable for the project at hand. In an embodiment, the vendor report 804 may include a detailed profile of each ranked vendor, providing insights into their strengths and weaknesses, areas of expertise, past performance, and overall suitability for the project. It might also highlight specific attributes or qualifications that make certain vendors stand out, such as innovative solutions, superior technology, or cost-effectiveness. Additionally, the report can include recommendations for which vendors might be best suited for certain types of projects or components of the RFP, based on their ranking and specific scores.

With continued reference to FIG. 8, a vendor report 804 may incorporate filtering mechanisms based on proposal codes 132, such as NAICS codes, to efficiently organize and present vendor information relevant to specific RFP requirements. By applying proposal codes as filters, the report can segment vendors into categories that align with their primary business activities or other defining characteristics. This method may allow decision-makers to quickly access a tailored list of vendors who are most likely to meet the specific needs of a project. For example, if an RFP requires services from the technology sector, the vendor report 804 may be filtered to show only those vendors classified under the relevant NAICS code for technology services. This targeted approach streamlines the review process, enabling quicker and more informed decision-making by highlighting vendors whose profiles are directly relevant to the RFP's scope.

With continued reference to FIG. 8, Processor 104 may generate a vendor report 804 by analyzing and compiling data gathered from a set of profiles 108 in response to an RFP 112. The process begins with the collection and standardization of data from each profile, ensuring that all information is consistent and formatted for comparison. Following data collection, the processor evaluates each profile 108 against the criteria outlined in the RFP using a scoring system. Each vendor receives a score based on how well their profile aligns with the RFP requirements. The ranked profiles may directly influence the generation of a vendor report. The processor may then compile these evaluations into a structured report. The vendor report may include detailed sections such as an executive summary, which highlights key findings and top candidates; detailed profiles, which provide insights into each vendor's qualifications and capabilities; and a comparative analysis that may include graphical representations of scores and rankings to visualize differences between vendors easily. In some cases, the report is formatted for readability and ease of use, often incorporating tables, charts, and bullet points to make the data accessible at a glance.

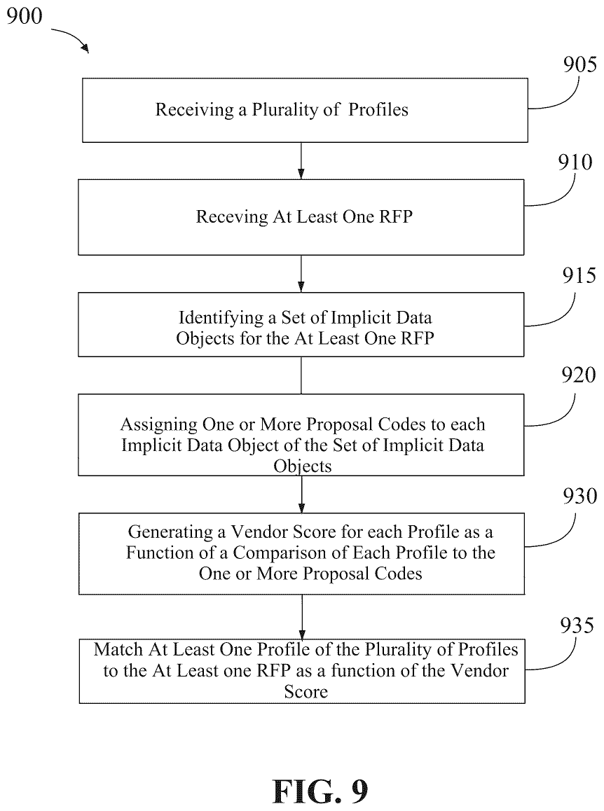

Referring now to FIG. 9, a flow diagram of an exemplary method 900 for assigning one or more proposal codes to a request for proposal is illustrated. At step 905, method 900 includes receiving, using at least a processor, a plurality of profiles. This may be implemented as described and with reference to FIGS. 1-7.

Still referring to FIG. 9, at step 910, method 900 includes receiving, using the at least a processor, at least one request for proposal (RFP). This may be implemented as described and with reference to FIGS. 1-7.

Still referring to FIG. 9, at step 915, method 900 includes identifying, using the at least a processor, a set of implicit data objects for the at least one RFP. This may be implemented as described and with reference to FIGS. 1-7. In an embodiment, identifying the set of implicit data objects may include identifying one or more keyword sets within the RFP, classifying the one or more keyword sets into one or more proposal categories, and identifying the set of implicit data objects as a function of the classification. In some cases, identifying the one or more keyword sets may include identifying the one or more keyword sets using a natural language processing model.

Still referring to FIG. 9, at step 920, method 900 includes assigning, using the at least a processor, one or more proposal codes to each implicit data object of the set of implicit data objects. Assigning the one or more proposal codes includes training a code machine learning model using code training data, wherein the code training data comprises examples of implicit data objects as inputs correlated to examples of proposal codes as outputs and assigning the one or more proposal codes to each implicit data object of the set of implicit data objects using the trained identifier machine learning model. This may be implemented as described and with reference to FIGS. 1-7. In an embodiment, the code machine learning model may include a LLM.

Still referring to FIG. 9, at step 925, method 900 includes generating, using the at least a processor, a vendor score for each profile as a function of a comparison of each profile to the one or more proposal codes. This may be implemented as described and with reference to FIGS. 1-7. In an embodiment, the method may further include ranking, using the at least a processor, each profile of the plurality of profiles as a function of the vendor scores. The method may additionally include generating, using the at least a processor, a vendor report as a function of the ranking of the plurality of profiles. In an additional embodiment, the method may include identifying, using the at least a processor, submission data as a function of the comparison. Identifying submission data may include identifying submission data using a web crawler.

Still referring to FIG. 9, at step 930, method 900 includes matching, using the at least a processor, at least one profile of the plurality of profiles to the at least one RFP as a function of the vendor score. This may be implemented as described and with reference to FIGS. 1-7. In an embodiment, the method may include assigning, using the at least a processor, one or more proposal codes to each profile of the plurality of profiles. In an embodiment, the proposal code may include a hierarchical proposal code and/or a North American Industry Classification System (NAICS) Code.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

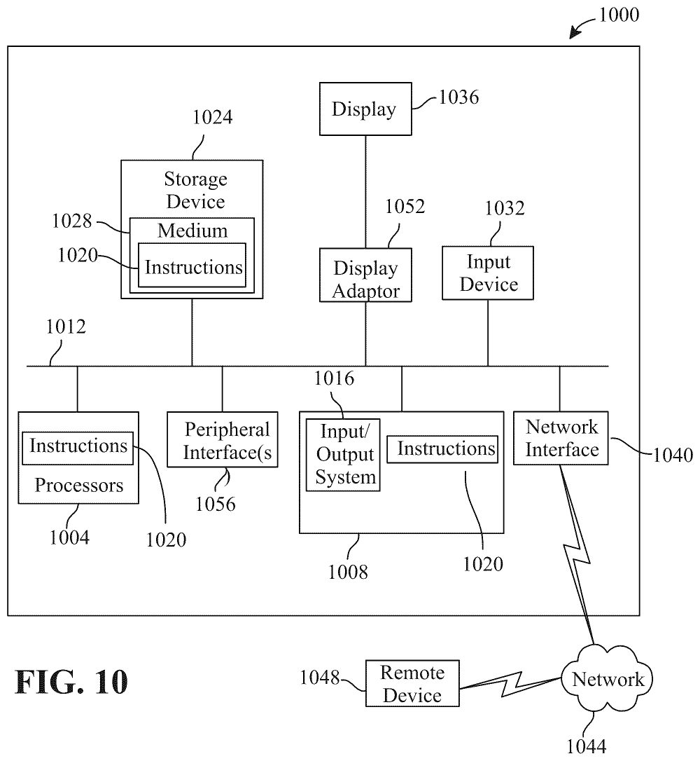

FIG. 10 shows a diagrammatic representation of one embodiment of a computing device in the exemplary form of a computer system 1000 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 1000 includes a processor 1004 and a memory 1008 that communicate with each other, and with other components, via a bus 1012. Bus 1012 may include any of several types of bus structures including, but not limited to, a memory bus, a memory controller, a peripheral bus, a local bus, and any combinations thereof, using any of a variety of bus architectures.

Processor 1004 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 1004 may be organized according to Von Neumann and/or Harvard architecture as a non-limiting example. Processor 1004 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), and/or system on a chip (SoC).

Memory 1008 may include various components (e.g., machine-readable media) including, but not limited to, a random-access memory component, a read only component, and any combinations thereof. In one example, a basic input/output system 1016 (BIOS), including basic routines that help to transfer information between elements within computer system 1000, such as during start-up, may be stored in memory 1008. Memory 1008 may also include (e.g., stored on one or more machine-readable media) instructions (e.g., software) 1020 embodying any one or more of the aspects and/or methodologies of the present disclosure. In another example, memory 1008 may further include any number of program modules including, but not limited to, an operating system, one or more application programs, other program modules, program data, and any combinations thereof.

Computer system 1000 may also include a storage device 1024. Examples of a storage device (e.g., storage device 1024) include, but are not limited to, a hard disk drive, a magnetic disk drive, an optical disc drive in combination with an optical medium, a solid-state memory device, and any combinations thereof. Storage device 1024 may be connected to bus 1012 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 1024 (or one or more components thereof) may be removably interfaced with computer system 1000 (e.g., via an external port connector (not shown)). Particularly, storage device 1024 and an associated machine-readable medium 1028 may provide nonvolatile and/or volatile storage of machine-readable instructions, data structures, program modules, and/or other data for computer system 1000. In one example, software 1020 may reside, completely or partially, within machine-readable medium 1028. In another example, software 1020 may reside, completely or partially, within processor 1004.

Computer system 1000 may also include an input device 1032. In one example, a user of computer system 1000 may enter commands and/or other information into computer system 1000 via input device 1032. Examples of an input device 1032 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 1032 may be interfaced to bus 1012 via any of a variety of interfaces (not shown) including, but not limited to, a serial interface, a parallel interface, a game port, a USB interface, a FIREWIRE interface, a direct interface to bus 1012, and any combinations thereof. Input device 1032 may include a touch screen interface that may be a part of or separate from display 1036, discussed further below. Input device 1032 may be utilized as a user selection device for selecting one or more graphical representations in a graphical interface as described above.

A user may also input commands and/or other information to computer system 1000 via storage device 1024 (e.g., a removable disk drive, a flash drive, etc.) and/or network interface device 1040. A network interface device, such as network interface device 1040, may be utilized for connecting computer system 1000 to one or more of a variety of networks, such as network 1044, and one or more remote devices 1048 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 1044, may employ a wired and/or a wireless mode of communication. In general, any network topology may be used. Information (e.g., data, software 1020, etc.) may be communicated to and/or from computer system 1000 via network interface device 1040.

Computer system 1000 may further include a video display adapter 1052 for communicating a displayable image to a display device, such as display device 1036. Examples of a display device include, but are not limited to, a liquid crystal display (LCD), a cathode ray tube (CRT), a plasma display, a light emitting diode (LED) display, and any combinations thereof. Display adapter 1052 and display device 1036 may be utilized in combination with processor 1004 to provide graphical representations of aspects of the present disclosure. In addition to a display device, computer system 1000 may include one or more other peripheral output devices including, but not limited to, an audio speaker, a printer, and any combinations thereof. Such peripheral output devices may be connected to bus 1012 via a peripheral interface 1056. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions, and additions may be made to that which is specifically disclosed herein without departing from the spirit and scope of the present invention.

What is claimed is:

1. An apparatus for assigning one or more proposal codes to a request for proposal, wherein the apparatus comprises:
at least a processor; and
a memory communicatively connected to the at least a processor, wherein the memory contains instructions configuring the at least a processor to:
receive a plurality of profiles;
receive at least one request for proposal (RFP);
identify a set of implicit data objects for the at least one RFP;
assign one or more proposal codes to each implicit data object of the set of implicit data objects, wherein assigning the one or more proposal codes comprises:
training a code machine learning model using code training data, wherein the code training data comprises examples of implicit data objects as inputs correlated to examples of proposal codes as outputs;
assigning the one or more proposal codes to each implicit data object of the set of implicit data objects using the trained code machine learning model;
generate a vendor score for each profile as a function of a comparison of each profile to the one or more proposal codes; and
match at least one profile of the plurality of profiles to the at least one RFP as a function of the vendor score.

2. The apparatus of claim 1, wherein the memory further instructs the processor to rank each profile of the plurality of profiles as a function of the vendor scores.

3. The apparatus of claim 2, wherein the memory further instructs the processor to generate a vendor report as a function of the ranking of the plurality of profiles.

4. The apparatus of claim 1, wherein the code machine learning model further comprises a large language model.

5. The apparatus of claim 1, wherein the one or more proposal codes comprises a hierarchical proposal code.

6. The apparatus of claim 1, wherein the one or more proposal codes comprises a North American Industry Classification System (NAICS) Code.

7. The apparatus of claim 1, wherein identifying the set of implicit data objects comprises:
identifying one or more keyword sets within the RFP;
classifying the one or more keyword sets into one or more proposal categories; and
identifying the set of implicit data objects as a function of the classification.

8. The apparatus of claim 7, wherein identifying the one or more keyword sets comprises identifying the one or more keyword sets using a natural language processing model.

9. The apparatus of claim 1, wherein the memory further instructs the processor to identify submission data as a function of the comparison.

10. The apparatus of claim 9, wherein identifying submission data comprises identifying submission data using a web crawler.

11. A method for assigning one or more proposal codes to a request for proposal, wherein the method comprises:
receiving, using at least a processor, a plurality of profiles;
receiving, using the at least a processor, at least one request for proposal (RFP);
identifying, using the at least a processor, a set of implicit data objects for the at least one RFP;
assigning, using the at least a processor, one or more proposal codes to each implicit data object of the set of implicit data objects, wherein assigning the one or more proposal codes comprises:
training a code machine learning model using code training data, wherein the code training data comprises examples of implicit data objects as inputs correlated to examples of proposal codes as outputs;
assigning the one or more proposal codes to each implicit data object of the set of implicit data objects using the trained code machine learning model;
generating, using the at least a processor, a vendor score for each profile as a function of a comparison of each profile to the one or more proposal codes; and
matching, using the at least a processor, at least one profile of the plurality of profiles to the at least one RFP as a function of the vendor score.

12. The method of claim 11, wherein the method further comprises ranking, using the at least processor, each profile of the plurality of profiles as a function of the vendor scores.

13. The method of claim 12, wherein the method further comprises generating, using the at least processor, a vendor report as a function of the ranking of the plurality of profiles.

14. The method of claim 11, wherein the code machine learning model further comprises a large language model.

15. The method of claim 11, wherein the one or more proposal codes comprises a hierarchical proposal code.

16. The method of claim 11, wherein the one or more proposal codes comprises a North American Industry Classification System (NAICS) Code.

17. The method of claim 11, wherein identifying the set of implicit data objects comprises:
identifying one or more keyword sets within the RFP;
classifying the one or more keyword sets into one or more proposal categories; and
identifying the set of implicit data objects as a function of the classification.

18. The method of claim 17, wherein identifying the one or more keyword sets comprises identifying the one or more keyword sets using a natural language processing model.

19. The method of claim 11, wherein the method further comprises identifying, using the at least a processor, submission data as a function of the comparison.

20. The method of claim 19, wherein identifying submission data comprises identifying submission data using a web crawler.
